(19) United States
(12) Patent Application Publication
(10) Pub. No.: US 2025/0050694 A1
(43) Pub. Date: Feb. 13, 2025

(54) MULTI-FIT PIN AND RECEIVER PIN LOCKING DEVICE

(71) Applicant: HORIZON GLOBAL AMERICAS INC., Plymouth, MI (US)

(72) Inventors: Stephen Gerald Sieczka, Plymouth, MI (US); Joshua Petrusha, Plymouth, MI (US); Cody Davis, Plymouth, MI (US)

(73) Assignee: HORIZON GLOBAL AMERICAS INC., Plymouth, MI (US)

(21) Appl. No.: 18/615,801

(22) Filed: Mar. 25, 2024

Related U.S. Application Data
(60) Provisional application No. 63/454,343, filed on Mar. 24, 2023.

(51) Int. Cl. B60D 1/06; B60D 1/48

(52) U.S. Cl. CPC B60D 1/065; B60D 1/485

(57) ABSTRACT

A receiver pin lock for insertion into first and second sized opposed engaging apertures of first and second hitch receivers is shown and described. The receiver pin lock may include a stem, a first stepped portion extend from the stem, and a lock member selectively engageable with the stem, the lock member preventing removal of stem from either of the first and second hitch receivers. In one embodiment, the receiver pin lock may further include a plurality of plunger members axially spaced and radially disposed on the stem. The plurality of plunger members may include a diameter larger than the first stepped portion and selectively engage with the second hitch receiver. In another embodiment, the receiver pin lock may further include an offset portion bent radially outward from the stem. Yet, in some embodiments, the receiver pin lock may further include a spiral portion bent radially outward and extending rotatably from the stem. Further still, the receiver pin lock may further including a biasing knob member.

### TECHNICAL FIELD

The present invention relates generally to a pin locking device and, more particularly, to a pin locking device for locking different sized drawbars and/or accessories with receiver hitches.

### BACKGROUND

Many vehicles are equipped with rear or front mounted receiver hitches used for towing of vehicles and as an attachment point for many other cargo accessories. These types of receiver hitches typically include a receiver opening or cavity used for the receipt of a drawbar or an accessory (such as a bike rack and other accessory carrying devices). Receiver openings come in various sizes—the size may depend upon the towing capabilities thereof. For example, receivertype trailer hitch assemblies are offered with a generally square receiver opening of 11/4 inches (32 mm) for Class I/II, 2 inches (51 mm) for Class III/IV, 2½ inches for Class V and even 3 inches for certain other Class V type receiver hitches.

A drawbar having a shank includes outer dimensions slightly smaller than the internal dimensions of the receiver opening and is slidable within the receiver opening. The drawbar is typically connected to the receiver opening by a pin inserted through the two tubular portions thereof and locked or clipped to prevent removal of the drawbar from the receiver hitch. The two components are both toleranced to ensure that the drawbar can be freely inserted and removed from the receiver opening. Similarly, an accessory carrying device (such as a bike rack, basket, grill holder and the like) includes a shank having outer dimensions slightly smaller than the internal dimensions of the receiver opening and is slidable within the receiver opening. The accessory carrying device is typically connected to the receiver opening by a pin inserted through the two tubular portions thereof and locked or clipped to prevent removal of the accessory carrying device from the receiver hitch. The two components are both toleranced to ensure that the accessory carrying device (or more specifically the shank portion thereof) can be freely inserted and removed from the receiver opening.

The shank of the drawbar and/or accessory carrying device may include an aperture and the receiver hitch may include a correspondingly shaped and aligned aperture through which the pin or lock may be inserted to operatively engage the drawbar and/or accessory carrying device with the receiver hitch. The lock may be used to generally prevent an unauthorized user from removing the drawbar and/or accessory carrying device from the receiver hitch.

However, apertures of different drawbars and receiver hitches may not be consistently the same, especially for receiver hitches of different classes. For example, the apertures of the drawbar and receiver hitch may be ½ of an inch, ⅝ of an inch or ¾ of an inch in diameter. In heavy duty towing applications, the receiver hitch may use a 3 inch receiver with a ¾ of an inch pin hole. In lighter towing applications, a bushing is may be used (3 inches to 2½ inches and/or 3 inches to 2 inches) with a towing ball mount designed for 2 inch receivers. Typical 2 inch receivers for towing ball mounts have a ⅝ of an inch pin hole and thus require a ⅝ of an inch pin. In combination, the result would be using a ⅝ of an inch pin in a ¾ of an inch pin hole. Overall, the differences in apertures and pins may require that a user have either a separate lock pin for ½ of an inch, ⅝ of an inch, and ¾ of an inch apertures or utilize a lock pin having a ⅝ of an inch sleeve that slides over the ½ of an inch pin lock, a lock pin having a ¾ of an inch sleeve to slide over the ⅝ of an inch pin lock, or even a lock pin having a ¾ of an inch sleeve to slide over the ½ of an inch pin lock that may to operatively engage the applicable apertures.

Unfortunately, however, this sleeve often gets lost or misplaced when not in use. Further, a user may inadvertently use the ½ of an inch pin in a ⅝ of an inch aperture or a ⅝ of an inch pin in a ¾ of an inch aperture, which would fit but would not operatively fit resulting in less than preferred operational condition and risks in use, including instability in the connection, bending, scuffing, and wear of the components, considerable noise of the assembly, and the possibility of the pin dislodging from the aperture during towing.

A need is therefore identified for an improved receiver pin lock that accommodates apertures of the drawbar, accessory carrying device, and receiver hitch of a plurality of sizes that is easy to utilize and does not require additional components that may otherwise become misplaced.

### DESCRIPTION OF THE DRAWINGS

Operation of the present teachings may be better understood by reference to the detailed description taken in connection with the following illustrations, wherein:

FIG. 1 is a perspective view of a vehicle having an adjustable pin lock operatively securing a drawbar with a receiver hitch;

FIG. 2 is a side view of an adjustable pin lock;

FIG. 3 is a side view of an adjustable pin lock with a plurality of plunger members;

FIG. 4 is a cross-sectional view of the embodiment of FIG. 3 along line A-A;

FIG. 5 is a side view of an adjustable pin lock with a plurality of plunger members;

FIG. 6 is a cross-sectional view of the embodiment of FIG. 5 along line B-B;

FIG. 7 is a side view of an adjustable pin lock with a plurality of plunger members;

FIG. 8 is a cross-sectional view of the embodiment of FIG. 7 along line C-C;

FIG. 9 is a front view of the adjustable pin lock;

FIG. 10 is a rear view of the adjustable pin lock;

FIG. 11 is a cross-sectional view of the adjustable pin lock operatively securing the drawbar with the receiver hitch;

FIG. 12 is a cross-sectional view of the adjustable pin locked operatively securing a drawbar with a receiver hitch;

FIG. 13 is a cross-sectional view of an embodiment of a set of plunger members of FIG. 3;

FIG. 14 is a cross-sectional view of another embodiment of the set of plunger members of FIG. 3;

FIG. 15 is a cross-sectional view of the embodiment of an offset portion of FIG. 5;

FIG. 16 is a cross-sectional view of the embodiment of a spiral portion of FIG. 7;

FIG. 17 is a side view of an adjustable pin lock with a biasing knob member;

FIG. 18A shows a side view of an embodiment of a pin as may be selectively coupled with a locking member;

FIG. 18B shows a cross-sectional view of an embodiment of the pin of FIG. 18A along line A-A;

FIG. 18C shows a perspective view of an embodiment of the pin FIG. 18A;

FIG. 18D shows a side view of an embodiment of the pin FIG. 18A;

FIG. 18E shows a side view of an embodiment of the pin FIG. 18A;

FIG. 19A shows a perspective view of an embodiment of a pin as may be selectively coupled with a locking member and an exploded view of a locking member;

FIG. 19B shows a perspective view of an embodiment of the pin of FIG. 19A selectively coupled with the locking member of FIG. 19A;

FIG. 19C shows a side view of an embodiment of the pin of FIG. 19A selectively coupled with the locking member of FIG. 19A;

FIG. 19D shows a cross-sectional view of an embodiment of the pin of selectively coupled with the locking member of FIG. 19C along line A-A;

FIG. 19E shows a zoomed in view of an embodiment of the pin selectively coupled with the locking member of FIG. 19C at B;

FIG. 20 shows a perspective view of an embodiment of a pin selectively coupled with a locking member;

FIG. 21 shows a perspective view of an embodiment of a pin selectively coupled with a locking member;

FIG. 22 shows a perspective view of an embodiment of a pin selectively coupled with a locking member;

FIG. 23A shows a perspective view of an embodiment of a pin as may be selectively coupled with a locking member and an exploded view of a locking member;

FIG. 23B shows a perspective view of an embodiment of the pin of FIG. 23A selectively coupled with the locking member of FIG. 23A;

FIGS. 23C-D show different cross-sectional views of an embodiment of locking member of FIG. 23A as it is selectively coupled with the pin of FIG. 23A;

FIG. 24A shows a perspective view of an embodiment of a pin as may be selectively coupled with a locking member and an exploded view of a locking member;

FIG. 24B shows a perspective view of an embodiment of the pin of FIG. 24A selectively coupled with the locking member of FIG. 24A;

FIG. 24C shows a cross-sectional view of an embodiment of locking member of FIG. 24A as it is selectively coupled with the pin of FIG. 24A;

FIG. 25A shows a perspective view of an embodiment of a pin as may be selectively coupled with a locking member and an exploded view of a locking member;

FIG. 25B shows a perspective view of an embodiment of the pin of FIG. 25A selectively coupled with the locking member of FIG. 25A;

FIG. 25C shows a cross-sectional view of an embodiment of locking member of FIG. 25A as it is selectively coupled with the pin of FIG. 25A;

FIG. 26A shows a perspective view of an embodiment of a pin as may be selectively coupled with a locking member and an exploded view of a locking member;

FIG. 26B shows a perspective view of an embodiment of the pin of FIG. 26A selectively coupled with the locking member of FIG. 26A;

FIG. 26C a cross-sectional view of an embodiment of locking member of FIG. 26A as it is selectively coupled with the pin of FIG. 26A;

FIG. 27A shows an exploded view of an embodiment of a locking member;

FIG. 27B shows a perspective view of an embodiment of the pin of FIG. 27A selectively coupled with the locking member of FIG. 27A;

FIG. 27C shows a side view of an embodiment of the pin of FIG. 27A selectively coupled with the locking member of FIG. 27A;

FIG. 27D shows a cross-sectional view of an embodiment of the locking member of FIG. 27C along line A-A;

FIG. 28A shows a cross sectional view of an embodiment of a pin as may be selectively coupled with a locking member and through a receiver hitch;

FIG. 28B shows a cross sectional view of an embodiment of a pin as may be selectively coupled with a locking member and through a receiver hitch;

FIG. 28C shows a cross sectional view of an embodiment of a pin as may be selectively coupled with a locking member and through a receiver hitch;

FIG. 29A shows a cross sectional view of an embodiment of a pin as may be selectively coupled with a locking member and through a receiver hitch;

FIG. 29B shows a perspective view of an embodiment of a pin as may be selectively coupled with a locking member and through a receiver hitch;

FIG. 30A shows a cross sectional view of an embodiment of a pin as may be selectively coupled with a locking member and through a receiver hitch;

FIG. 30B shows a perspective view of an embodiment of a pin as may be selectively coupled with a locking member and through a receiver hitch;

FIG. 31A shows a cross sectional view of an embodiment of a pin as may be selectively coupled with a locking member and through a receiver hitch;

FIG. 31B shows a perspective view of an embodiment of a pin as may be selectively coupled with a locking member and through a receiver hitch;

FIG. 32A shows a cross sectional view of an embodiment of a pin as may be selectively coupled with a locking member and through a receiver hitch;

FIG. 32B shows a perspective view of an embodiment of a pin as may be selectively coupled with a locking member and through a receiver hitch;

FIG. 33A shows a perspective view of an embodiment of a pin as may be selectively coupled with a locking member and an exploded view of a locking member;

FIG. 33B shows a cross-sectional view of an embodiment of locking member as it is selectively coupled with the pin of FIG. 33A;

FIG. 34A shows a cross-sectional front view of an embodiment of locking member of FIG. 33A as it is being selectively coupled with the pin of FIG. 33A;

FIG. 34B shows a cross-sectional front view of an embodiment of locking member of FIG. 33A as it is being selectively coupled with the pin of FIG. 33A;

FIG. 34C shows a cross-sectional front view of an embodiment of locking member of FIG. 33A as it is being selectively coupled with the pin of FIG. 33A;

FIG. 34D shows a cross-sectional side view of an embodiment of locking member of FIG. 33A as it is being selectively coupled with the pin of FIG. 33A;

FIG. 35 shows a perspective view of an embodiment of a pin as may be selectively coupled with a locking member and an exploded view of a locking member;

FIG. 36A shows a cross-sectional view of an embodiment of locking member FIG. 35 as it is being selectively coupled with the pin FIG. 35;

FIG. 36B shows a cross-sectional view of an embodiment of locking member FIG. 35 as it is being selectively coupled with the pin FIG. 35;

FIG. 36C shows a cross-sectional view of an embodiment of locking member FIG. 35 as it is being selectively coupled with the pin FIG. 35;

FIG. 37A shows a cross sectional view of an embodiment of a pin as may be selectively coupled with a locking member and through a receiver hitch;

FIG. 37B shows a cross sectional view of an embodiment of a pin as may be selectively coupled with a locking member and through a receiver hitch; and

FIG. 37C shows a cross sectional view of an embodiment of a pin as may be selectively coupled with a locking member and through a receiver hitch.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

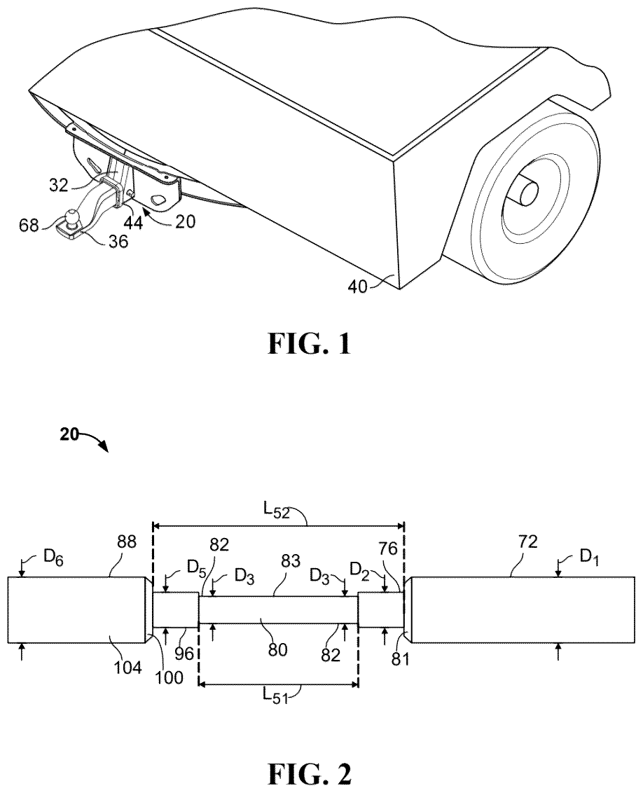

FIGS. 1-10 show an exemplary embodiment of a receiver pin lock 20. As shown in FIG. 1, the receiver pin lock 20 may be operatively engaged with generally aligned engaging apertures 24, 28 of a receiver hitch 32 and drawbar 36. The receiver hitch 32 may be operatively attached with a vehicle 40 in any appropriate manner. It is noted that the present teachings are not limited to the receiver hitch 32 shown and described herein and any current or newly developed receiver hitch may be utilized without departing from the present teachings. By way of a non-limiting example, the receiver hitch 32 may be attached to a frame (not shown) of the vehicle 40, such as through use of fasteners, welding, or the like. As illustrated, the receiver hitch 32 may include a receiver tube 44 adapted to selectively accept a drawbar 36 of a corresponding shape and size as described herein. Even if not explicitly described, it is noted that any of the receiver hitch 32, drawbar 36, apertures 24, 28 receiving tube 44, and vehicle 40 as shown and described by at least FIG. 1 may be used with any of the embodiments of the pins and locks described herein.

The receiver tube 44 may be mounted to the receiver hitch 32 by any appropriate mounting techniques, such as by way of non-limiting examples, fastening, welding, or the like. In some embodiments, the receiver tube 44 may include a generally square receiver opening 48 of approximately 11/4 inches (32 mm) for Class I/II, 2 inches (51 mm) for Class III/IV, 2½ inches for Class V and even 3 inches for certain other Class V type receiver hitches. It is to be expressly understood that other sizes or shapes of the receiver tube 44 and any receiver opening 48 thereof may be used without departing from the present teachings.

The receiver tube 44 may include an interior portion 52 and an exterior portion 56. The interior portion 52 may terminate at the receiver opening 48. The receiver tube 44 may also include at least two engaging apertures 24 disposed apart from one another. By way of a nonlimiting example, the engaging apertures 24 may be generally aligned, such as axially aligned, on opposing sides 60 of the receiver tube 44. The engaging apertures 24 may extend entirely through the opposing sides 60 of the receiver tube 44 and may be configured to receive any of the receiver pin locks as described herein including receiver pin lock 20.

The drawbar 36 may be of any appropriate configuration and may be selectively engaged with the receiver hitch 32, see FIG. 1. By way of a non-limiting example, the drawbar 36 may include an exterior portion 64 having a generally corresponding shape to that of the interior portion 52 of the receiver tube 44. The drawbar 36 may also have an external size or shape slightly less than the internal size or shape of the receiver tube 44. This may enable the drawbar 36 to be inserted within the receiver tube 44 in a telescoping manner, as shown in FIG. 1.

In some embodiments, the drawbar 36 may include a trailer hitch ball 68 mounted thereto in any appropriate manner; including, by way of a non-limiting example, via fasteners, welding, or the like. Further, the trailer hitch ball 68 may be monolithically formed with the drawbar 36. It should be understood that the term drawbar is used throughout to describe the portion that is insertable into the receiver tube 44 and is not limited to a ball mount and trailer hitch ball as shown. The drawbar 36 may be attached to any appropriately configured ball mount, cargo accessory, such as bicycle carriers, ski carriers, cargo compartments, platforms, baskets, storage boxes, lights, steps, accessory members, cargo trays, pintle mounts and other types of receiver hitch-mounted devices.

Regardless of the accessory or ball mount utilized with the drawbar 36, the drawbar 36 may be inserted into the interior portion 52 of the receiver hitch 32. The receiver pin lock 20 may be utilized for insertion into the engaging apertures 24, 28 of the receiver hitch 32 and the drawbar 36. The receiver pin lock 20 may operatively secure the drawbar 36 with the receiver hitch 32 such that the drawbar 36 is generally prevented from being removed from the receiver hitch 32 by an unauthorized person. However, it should be understood that the present teachings are not limited to this configuration-any appropriate configuration between the drawbar 36 and receiver hitch 32 may be utilized with the receiver pin lock 20.

Referring to FIG. 2, the receiver pin lock 20 may include a stop portion 72, a first stepped portion 76 extending from the stop portion 72, and a shank 80 extending from the stepped portion 76. The stop portion 72, first stepped portion 76 and shank 80 may be monolithically formed with each other or may be attached through subsequent operation, e.g., adhering, welding, fastening, or the like. The stop portion 72 may be configured to not pass through either of or both of the engaging apertures 24, 28 of the receiver hitch 32 and drawbar 36, respectively. By way of a non-limiting example, the stop portion 72 may be a generally cylindrical shape having a diameter D₁. The diameter D₁ may be of any appropriate size that prevents such from passing through either of or both of the engaging apertures 24, 28. For example D₁ may be larger than ⅝ of an inch, e.g., it may be approximately 1 inch. It should be understood, however, that the stop portion 72 may be of any appropriate shape and size and is not limited to that shown and described.

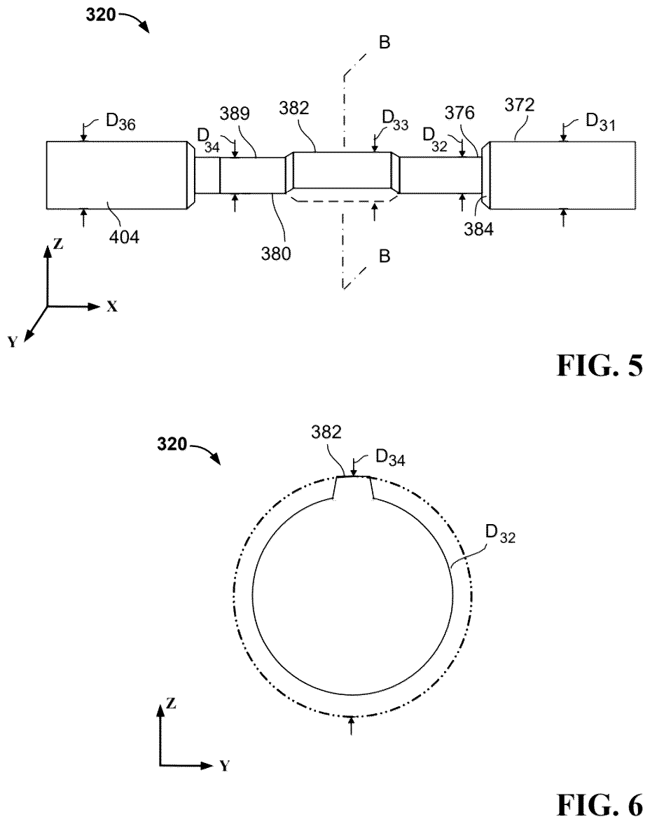

The stepped portion 76 may be of any appropriate shape and size. By way of a nonlimiting example, the stepped portion 76 may extend from the stop portion 72 and be of a smaller diameter D₂ than the stop portion 72 diameter D₁, such as being 37.5% less in diameter than the stop portion 72. As shown in FIG. 5, the stepped portion 76 may have a generally circular crossectional shape with the diameter D₂ being approximately ⅝ of an inch.

Further, a transition portion 81 may be positioned between the stop portion 72 and stepped portion 76. The transition portion 84 may be a continuous or discontinuous transition between the stop portion 72 and stepped portion 76, e.g., the transition portion 84 may act as a ramp between the stop portion 72 and stepped portion 76. The transition portion 84 may be of any appropriate configuration and is not limited to that shown. Further still, in some embodiments the receiver pin lock 20 may not include the transition portion 84 and the stop portion 72 may transition directly into or directly abut the stepped portion 76. As shown, the transition portion 84 may be smaller than the stop portion 72, but larger than the stepped portion 76. In general, the transition portion may be beveled or tapered.

The shank 80 may extend from the stepped portion 76 and be integrally formed therewith. In some embodiments, the shank 80 may be monolithically formed with the stepped portion 76, transition portion 84 and stop portion 72. In some embodiments, the shank 80 may be attached with the stepped portion 76 in any appropriate manner, including, without limitation by adhering, welding or fastening. In yet some embodiments, the shank 80 may be monolithically formed with the stepped portion 76 and transition portion 84 or just the stepped portion 76. The shank 80 may have a generally circular cross-sectional shape and be of a diameter D₃ generally less than the diameter D₂ of the stepped portion 76. For example, the shank 80 may have a diameter D₃ of about ½ of an inch and this diameter D₃ may generally extend the entire length of the shank 80, but may also extend a substantial portion of the length of the shank 80, including, without limitation a majority portion of the length of the shank 80. Further, end portions 82 of the shank 80 may have a diameter D₃ of approximately ½ of an inch whereby a remaining central portion 83 thereof may have a diameter that is less than that of the end portions, e.g. 7/16 of an inch.

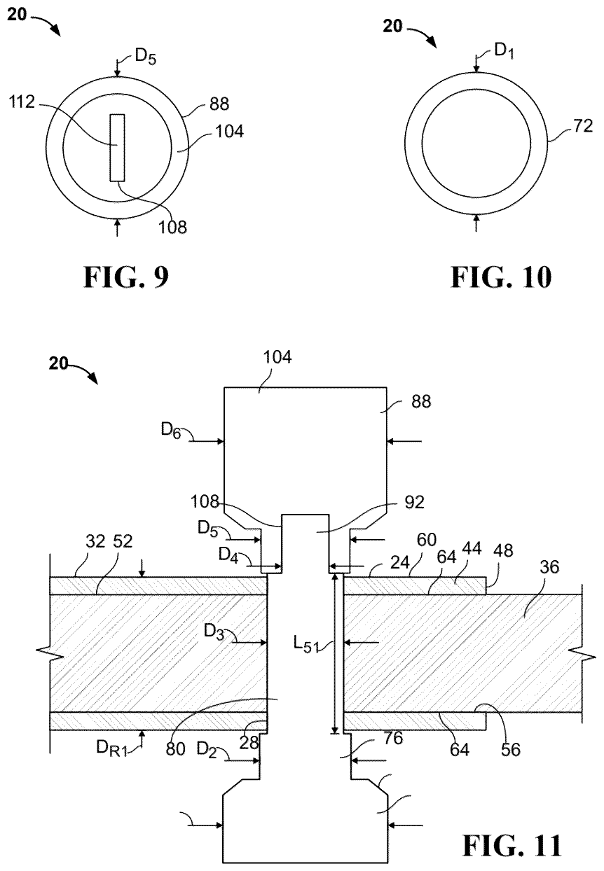

The receiver pin lock 20 may further include a lock member 88 that selectively attaches with the shank 80 in any appropriate manner. In such embodiments, the shank 80 may include an engaging end portion 92 that extends from the shank 80. The engaging end portion 92 may constitute any appropriate configuration. As shown in FIGS. 8 and 9 as an exemplary embodiment, the engaging end portion 92 may have a diameter D₄ that is less than the diameter D₃ of the remainder of the shank 80, e.g., it may be ⅜ of an inch. However, the present teachings are not limited to this configuration. For example, the engaging end portion 92 may be of generally an equivalent diameter of the remainder of the shank 80 D₃. Further still, the engaging end portion 92 may have a generally larger diameter than the remainder of the shank 80 D₃. The engaging end portion 92 may be configured to selectively engage with the lock member 88 in any appropriate manner.

The lock member 88 may include a stepped portion 96, a transition portion 100 extending from the stepped portion 96 and a lock body 104 extending from the transition portion 100. The stepped portion 96 may be of any appropriate shape and size. By way of a non-limiting example, the stepped portion 96 may be of a smaller diameter than lock body 104. As shown in FIG. 2, the stepped portion 96 may have a generally circular cross-sectional shape with a diameter D₅ of approximately ⅝ of an inch. Further, the transition portion 100 may be positioned between the stepped portion 96 and the lock body 104. The transition portion 100 may be a continuous or discontinuous transition between stepped portion 96 and the lock body 104. The transition portion 100 may be of any appropriate configuration and is not limited to that shown.

The lock body 104 may be of any appropriate configuration and is not limited to that shown and described herein. The lock body 104 may have a diameter D₆ that is greater than ⅝ of an inch, such as being approximately 1 inch. The lock body 104 may include an opening 108 configured to receive the engaging end portion 92 of the shank 80. As shown, the engaging end portion 92 is of a configuration such that it may be selectively engaged with the opening 108.

It should be understood that while the engaging end portion 92 is shown as being inserted into the lock body 104 the present teachings are not limited to this configuration. In other embodiments, the lock body 104 may be inserted into the engaging end portion 92—opposite of what is shown in the drawings. Any appropriate configuration of selective engagement of the engaging end portion 92 of the shank and lock body 104 may be utilized without departing from the present teachings.

Additional embodiments of a pin lock according the present teachings are described below. In the descriptions, all of the details and components may not be fully described or shown. Rather, the features or components are described and, in some instances, differences with the above-described embodiments may be pointed out. Moreover, it should be appreciated that these additional embodiments may include elements or components utilized in the above described embodiments although not shown or described. Thus, the descriptions of these additional embodiments are merely exemplary and not all-inclusive nor exclusive. Moreover, it should be appreciated that the features, components, elements and functionalities of the various embodiments may be combined or altered to achieve a desired pin lock without departing from the spirit and scope of the present teachings.

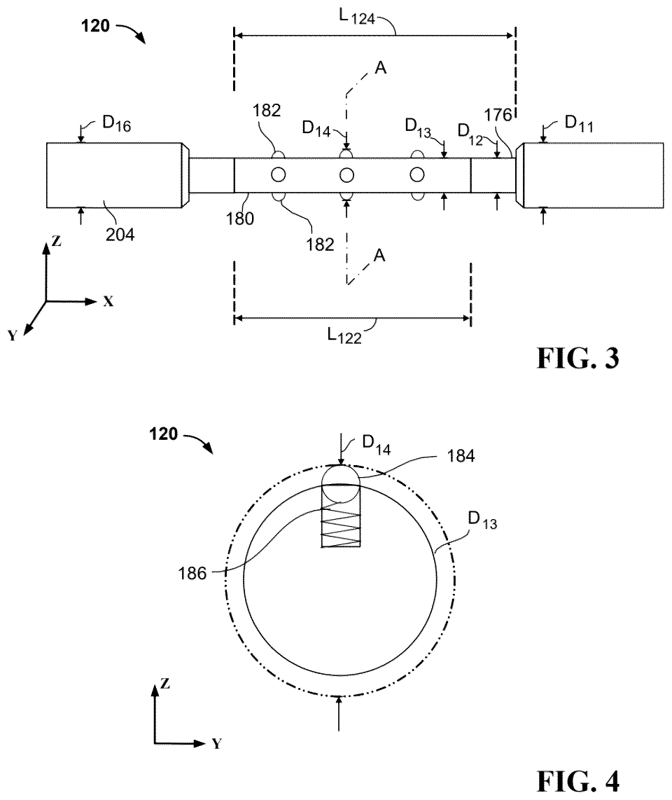

In embodiments as shown in FIGS. 3-4, a pin lock 120 may include a shank 180. The shank 180 may have a generally circular cross-sectional shape and be of a diameter D₁₃ that may be same as the diameter D₁₂ of a stepped portion 176. By way of a non-limiting example, the shank 180 may have a diameter D₁₃ of about ⅝ of an inch and this diameter D₁₃ may generally extend the entire length of the shank 180.

Further, the shank 180 may include a plurality of plunger members 182 generally axially spaced and radially disposed on the shank 180. In a particular embodiment shown in FIG. 3, the pin lock 120 may comprise four radially disposed sets of the plurality of plunger members 182. Each radially disposed set of the plurality of plunger members 182 may include three axially spaced plunger members 182 respectively. However, these numbers are merely exemplary and not limiting. The plurality of plunger members 182 may be substantially similar to one another; however, the present teachings contemplate any appropriate shapes or numbers of the plurality of plunger members 182, including, without limitation, one, three, four, etc. In some embodiments, the plurality of plunger members 182 may of a different configuration. Moreover, the plunger members 182 may be positioned along the shank 180 in any configuration. The present teachings are not limited to a specific configuration. For example, the plunger members 182 may be generally (i.e., within ½ inch or less) along an axially extending line of the shank 180 and may be generally (i.e., within ½ inch or less) evenly spaced from one another on the shank 180. The plunger members 182 may also be randomly positioned along the shank 180 in any position thereon. The plunger members 182 may be positioned generally diagonally (i.e., within ½ inch or less) along a diagonal line of the shank 180. Any configuration of the plunger members 182 being on the shank 180 is contemplated hereby.

Further, in another embodiment shown in FIG. 3, the distance L₁₂₂ may be between 2.0 to 3.0 inches in length and L₁₂₄ may be between 2.5 to 3.5 inches in length. In some embodiments, the distance L₁₂₂ may be 2.5 inches and L₁₂₄ may be 3.0 inches in length. The present disclosure, however, is not limited to any particular lengths.

Referring to FIG. 4, the plurality of plunger members 182 may further include a plunger ball 184 and a plunger biasing member 186. By way of a non-limiting example, the plurality of plunger members 182 may be threaded, press fit, friction fit, attached through use of a fastener, welding or adhered to the shank 180. The plunger ball 184 may be positioned radially outward against mating surface of the different sized drawbars or accessory carrying devices and receiver hitches when it is inserted therein. The plunger biasing member 186 may provide biasing force to the plunger ball 184. This configuration may force the ball 184 against an inner wall of the different sized drawbars of the accessory carrying device and receiver hitches. In such embodiment, the plurality of plunger members 182 may have a diameter D₁₄ that is larger than the diameter D₁₃. In some embodiment shown in FIG. 4, the shank 180 may have the diameter D₁₄ of about ¾ of an inch and the diameter D₁₃ of about ⅝ of an inch. The plurality of plunger members 182 of the receiver pin lock 120 may be symmetrically or generally symmetrically (i.e., minor tolerance differences, slight differences in configuration or shape) formed along line A-A.

The receiver pin lock 120 may be configured to be reversible, i.e., it does not matter which side the lock body 204 is positioned to operatively secure the receiver pin lock 120 with the receiver hitch 32 and drawbar 36 (or any accessory carrying device). By way of a nonlimiting example, the diameter D₃₆ of the lock body 404 may be generally equivalent to the diameter D₁₁ of the stop portion 172. Further, the diameter D₁₂ of the stepped portion 176 may be generally equivalent to the diameter D₄ of the stepped portion 196. Further still, the diameter D₃ of the shank 180 may be generally consistent the length of the shank 180. The present teachings, however, are not limited to this configuration. For example, the diameter D₁₆ of the lock body 204 may be different from that the diameter D₁ of the stop portion 172.

In operation shown in FIGS. 3-4, the plunger ball 184 may be selectively engaged with and disengaged from the different sized drawbars, accessory carrying devices and receiver hitches.

In another embodiment of a pin lock 320 as shown in FIGS. 5-6, a shank 380 may further include an offset portion 382. The offset portion 382 may bent radially outward along z axis relative to a stepped portion 376 at an angle and extend from the stepped portion 376. The offset portion 382 may include the angle such that the offset portion 382 may be offset from the stepped portion 376 along the x-axis, such as in a generally Ω-shape. In some embodiments, the offset portion 382 may be arcuate. This configuration may force the offset portion 382 against an inner wall of the different sized drawbars accessory carrying device and receiver hitches. In such embodiment, the offset portion 382 may have a diameter D₃₃ that is larger than the diameter D₃₂. In operation shown in FIGS. 5-6, the offset portion 382 may be selectively engaged with and disengaged from the different sized drawbars, accessory carrying devices and receiver hitches.

The offset portion 382 may extend from the stepped portion 376 and be integrally formed therewith. In some embodiments, the offset portion 382 may be monolithically formed with the stepped portion 376, transition portion 384, stop portion 372 and the shank 380. In some embodiments, the offset portion 382 may be attached with the stepped portion 376 in any appropriate manner, including, without limitation by adhering, welding or fastening. The offset portion 382 of the receiver pin lock 320 may be symmetrically or generally symmetrically (i.e., minor tolerance differences, slight differences in configuration or shape) formed along line B-B.

The receiver pin lock 320 may be configured to be reversible, i.e., it does not matter which side the lock body 404 is positioned to operatively secure the receiver pin lock 320 with the receiver hitch 32 and drawbar 36 (or any accessory carrying device). By way of a nonlimiting example, the diameter D₃₆ of the lock body 404 may be generally equivalent to the diameter D₃₁ of the stop portion 372. Further, the diameter D₃₂ of the stepped portion 376 may be generally equivalent to the diameter D₄ of the stepped portion 396. Further still, the diameter D₃ of the shank 380 may be generally consistent the length of the shank 380. The present teachings, however, are not limited to this configuration. For example, the diameter D₃₆ of the lock body 404 may be different from that the diameter D₃₁ of the stop portion 372.

The end portion 389 may bent radially inward and extend along the x-axis from the offset portion 382. In such embodiment, the shank 380 may have a generally circular crossectional shape and be of a diameter D₃₄ that is same as the diameter D₃₂ of the stepped portion 376. By way of a non-limiting example, the shank 380 may have a diameter D₃₃ of about ¾ of an inch.

Referring to FIG. 6, the offset portion 382 may have the diameter D₃₃ that is larger than the diameter D₃₂. In some embodiments, the offset portion 382 may have the diameter D₃₃ of about ¾ of an inch and the diameter D₃₂ of about ⅝ of an inch. In operation shown in FIGS. 5-6, the offset portion 382 may be selectively engaged with and disengaged from the different sized drawbars, accessory carrying devices and receiver hitches.

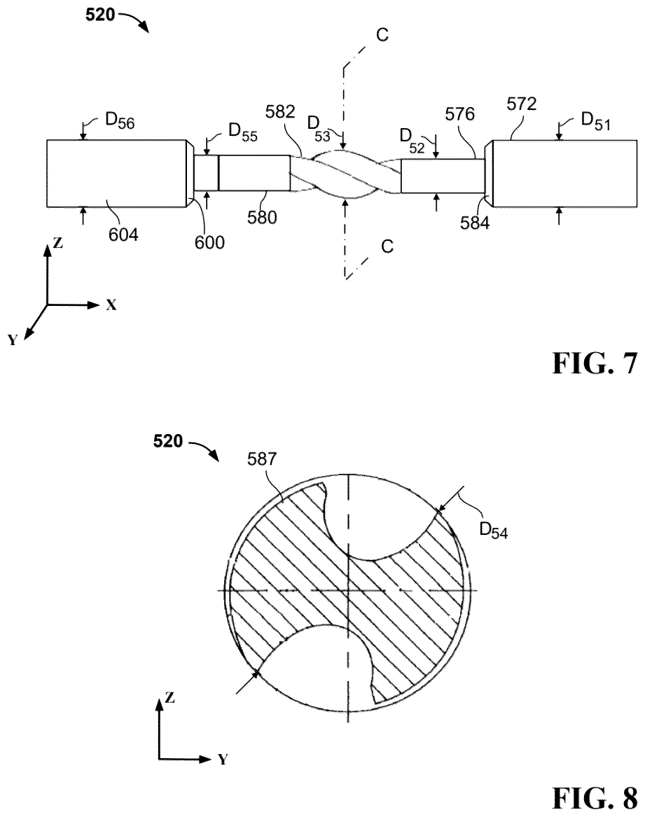

Yet, in some embodiments of a pin lock 520 as shown in FIGS. 7-8, a shank 580 may further include a spiral portion 582. The spiral portion 582 may bent radially outward along z-axis relative to a stepped portion 576 and extend rotatably from the stepped portion 576. The spiral portion 582 may include a spiral shape such that the spiral portion 582 may be spiral from the stepped portion 576 along the x-axis, such as in a generally drill bit shape. In some embodiments, the spiral portion 582 may be arcuate. This configuration may force the spiral portion 582 against an inner wall of the different sized drawbars and receiver hitches. In such embodiment, the spiral portion 582 may have a diameter D₅₃ that is larger than the diameter D₅₂. In operation shown in FIGS. 7-8, the spiral portion 582 may be selectively engaged with and disengaged from the different sized drawbars, accessory carrying devices and receiver hitches.

The spiral portion 582 may extend from the stepped portion 576 and be integrally formed therewith. In some embodiments, the spiral portion 582 may be monolithically formed with the stepped portion 576, transition portion 584, stop portion 572 and the shank 580. In some embodiments, the spiral portion 582 may be attached with the stepped portion 576 in any appropriate manner, including, without limitation by adhering, welding or fastening. The spiral portion 582 of the receiver pin lock 520 may be symmetrically or generally symmetrically (i.e., minor tolerance differences, slight differences in configuration or shape) formed along line C-C.

The receiver pin lock 520 may be configured to be reversible, i.e., it does not matter which side the lock body 604 is positioned to operatively secure the receiver pin lock 520 with the receiver hitch 32 and drawbar 36 (or any accessory carrying device). By way of a nonlimiting example, the diameter D₅₆ of the lock body 604 may be generally equivalent to the diameter D₅₁ of the stop portion 572. Further, the diameter D₅₂ of the stepped portion 76 may be generally equivalent to the diameter D₄ of the stepped portion 96. Further still, the diameter D₃ of the shank 80 may be generally consistent the length of the shank 80. The present teachings, however, are not limited to this configuration. For example, the diameter D₅₆ of the lock body 604 may be different from that the diameter D₅₁ of the stop portion 572.

The lock member 88 may include a lock 108 positioned in the lock body 104-a portion of which is shown in FIG. 9. The lock 108 may selectively engage and lock the lock body 104 with the engaging end portion 92 of the shank 80. The lock 108 may be of any known or future developed configuration, such as that shown and described in U.S. Pat. No. 6,543,260, incorporated herein by reference in its entirety. The lock 108 may include an opening 112 configured for insertion of a key to operate the lock 108. The key may be inserted into the opening 112 and rotated so as to lock and unlock the lock 108. In some embodiments, the lock 108 being locked may operatively secure the lock body 104 with the engaging end portion 92 of the shank 80. Unlocking the lock 108 may release the engaging end portion 92 from the shank 80. While a keyed lock 108 is shown and described, the present teachings are not limited to this configuration. The lock 108 may be a combination lock, round key lock, pad lock, or any other lock configuration.

The receiver pin lock 20 may be configured to be reversible, i.e., it does not matter which side the lock body 104 is positioned to operatively secure the receiver pin lock 20 with the receiver hitch 32 and drawbar 36 (or any accessory carrying device). By way of a nonlimiting example, the diameter D₆ of the lock body 104 may be generally equivalent to the diameter D₁ of the stop portion 72. Further, the diameter D₂ of the stepped portion 76 may be generally equivalent to the diameter D₄ of the stepped portion 96. Further still, the diameter D₃ of the shank 80 may be generally consistent the length of the shank 80. The present teachings, however, are not limited to this configuration. For example, the diameter D₆ of the lock body 104 may be different from that the diameter D₁ of the stop portion 72.

In operation, the receiver pin lock 20 may be configured to be operatively inserted into and locked in a plurality of different sized drawbars and receiver hitches. By way of a nonlimiting example, the receiver pin lock 20 may be configured to be operatively inserted into and locked in at least both of a 1¼ and 2 inch receiver hitches. In many embodiments of the 1¼ inch receiver hitch 32 the engaging apertures 24 may be approximately ½ of an inch in diameter. In such embodiments, the distance D_{R1} between the engaging apertures 24 of the receiver hitch 32 may be such that the shank 80 of the receiver pin lock 20 extends between the engaging apertures 24—see FIG. 5. The shank 80 may extend for a length L₅₁ whereby L₅₁ may be generally equivalent or slightly greater than the distance D_{R1}. This results in the shank 80 extending between the engaging apertures 24 or slightly beyond both of the engaging apertures 24. In such embodiments, the diameter D₃ of the shank 80 may be ½ of an inch and may operatively engage with the ½ of an inch diameter engaging apertures 24 of the receiver hitch 32. The engaging apertures 28 of the drawbar 36 may be of a generally corresponding size to that of the engaging apertures 24. In such embodiments, the stepped portions 76 and 96 extend from the shank 80 exterior to the drawbar 36 and receiver hitch 32. The stepped portions 76 and 96 may each engage with a side of the receiver hitch 32 to further provide a tight operative fit for the receiver pin lock 20.

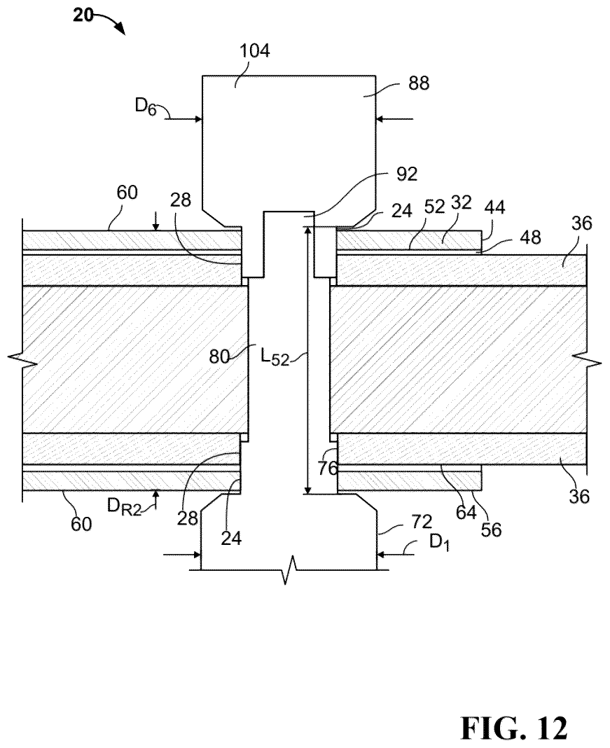

Further, the receiver pin lock 20 may also be utilized to be operatively inserted into and locked in a 2 inch receiver hitch 32 and drawbar 36. In many embodiments of the 2 inch receiver hitch 32 may include engaging apertures 24 of approximately ⅝ of an inch in diameter. In such embodiments, the distance D_{R2} between the engaging apertures 24 of the receiver hitch 32 may be such that the stepped portions 76 and 96 of the receiver pin lock 20 extends between the engaging apertures 24—see FIG. 12. The stepped portions 76 and 96 may extend apart from one another for a length L_{S2} whereby L_{S2} may be generally equivalent or slightly greater than the distance D_{R2}. This results in the stepped portions 76 and 96 extending into the engaging apertures 24 or slightly beyond both of the engaging apertures 24. In such embodiments, the distance D_{R2} from the engaging apertures 28 of the drawbar 36 may be such that when inserted the stepped portions 76 and 96 of the receiver pin lock 20 operatively engage the engaging apertures 24 and 28 of the receiver hitch 32 and drawbar 36, respectively. The stepped portions 76 and 96 may have a ⅝ of an inch diameter that may operatively engage with the ⅝ of an inch diameter of the engaging apertures 24 and 28. This may permit a single receiver pin lock 20 to be operatively utilized with drawbars and receiver hitches of at least 1¼ and 2 inches having engaging apertures 24, 28 of approximately ½ of an inch and ⅝ of an inch, respectively. In such embodiments, the stop portion 72 and the lock body 104 may engage sides of the receiver hitch 32 to provide a tight fit.

During operation, the user may remove the lock member 88 from the shank 80. The user may insert the shank 88 into and through the engaging apertures 24 and 28 of the receiver hitch 32 and drawbar 36 until the engaging end portion 92 of the shank 80 extends from a side of the receiver hitch 32 and drawbar 36 opposite to a side in which the shank 88 is inserted. The lock member 88 may be operatively and lockingly engaged with the engaging end portion 92. The user may lock the lock member 88, which may generally prevent the receiver pin lock 20 from being removed, which may lockingly secure the receiver hitch 32 with the drawbar 36.

The receiver pin lock 20 may be of such a configuration that the appropriate portion of the receiver pin lock 20 may engage the engaging apertures 24 and 28 of the receiver hitch 32 and drawbar 36 of the applicable size. For example and as shown in FIG. 5, the portion of the shank 80 having the diameter D₃ of approximately ½ of an inch may operatively engage the engaging apertures 24 and 28 for those 1¼ inch hitch receivers 32 and corresponding drawbar 36. In the 1¼ inch hitch receivers 32 and its corresponding drawbar 36 the respective engaging apertures 24, 28 may be approximately ½ of an inch in diameter. The diameter D₃ of the shank 80 may be ½ inches, which may provide a tight fit with the engaging apertures 24, 28.

Further as shown in FIG. 12, the diameters D₂ and D₅ of the stepped portions 76 and 96 may be approximately ⅝ of an inch and may operatively engage the engaging apertures 24 and 28 for those 2 inch hitch receivers 32 and corresponding drawbar 36. In the 2 inch hitch receivers 32 and its corresponding drawbar 36 the respective engaging apertures 24, 28 may be approximately ⅝ of an inch in diameter. As the diameters D₂ and D₅ of the stepped portions 76 and 96 may be ⅝ inches, which may provide a tight fit with the engaging apertures 24, 28. This tight fit may eliminate the necessity for additional components, such as sleeves and may reduce the uncertainty of which size receiver lock should be used. The receiver pin lock 20 may “automatically” fit with the appropriately sized engaging apertures 24, 28 and corresponding receiver hitch 32 and drawbar 36, respectively.

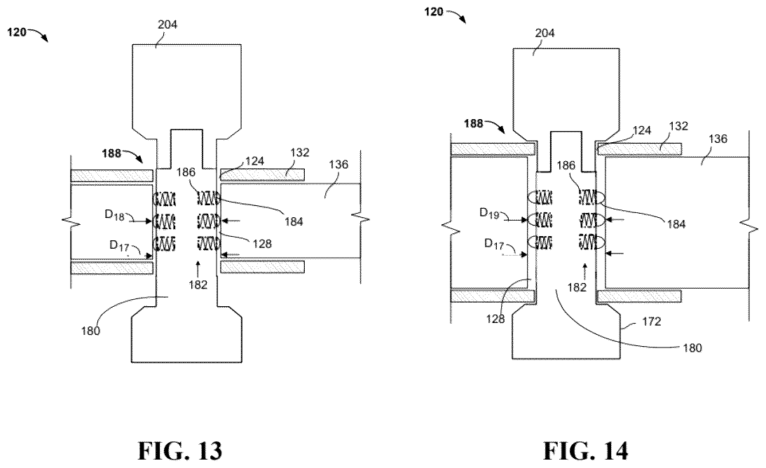

In operation as shown in FIGS. 13-14, the receiver pin lock 120 may be configured to be operatively inserted into and locked in a plurality of different sized drawbars and receiver hitches. By way of a non-limiting example, the receiver pin lock 120 may be configured to be operatively inserted into and locked in at least both of 2½ and 3 inch drawbar 136. In such embodiments, the engaging apertures 124 of the receiver hitch 132 may be approximately ⅝ of an inch in diameter in FIGS. 13 and ¾ of an inch in diameter as illustrated in FIG. 14.

In an exemplary embodiment shown in FIGS. 13 and 14, the plunger ball 184 of the plunger member 182 may be biased towards the engaged position. The plunger ball 184 of the plunger member 182 may be biased by the plunger biasing member 186. For example, a spring may be secured at a first end to the plunger ball 184 and secured at a second end to any appropriate structural member of the plunger biasing member 186. In such an arrangement, the spring may be positioned so that when the plunger ball 184 is moved towards the engaged position, the spring may be compressed from its natural position and applies a force on the plunger ball 184 to encourage it to the engaged position.

The diameter D₁₄ of the plunger ball 184 of the plunger member 182 in its natural position shown in FIGS. 3 and 4 may be generally greater than the diameter Dis of the plunger ball 184 of the plunger member 182 in FIG. 13. This results the plunger ball 184 being compressed between the engaging apertures 128 of the drawbar 136 and the diameter D₁₈ of the plunger ball 184 may be generally equivalent with the diameter D₁₇ of the engaging apertures 128. In such embodiments, the diameter D₁₈ of the of the plunger ball 184 of the plunger member 182 may be ⅝ of an inch and may operatively engage with the ⅝ of an inch diameter of the engaging apertures 128 of the drawbar 136. In such embodiments, the receiver pin lock 120 may be selectively engaged with and disengaged from the differently sized drawbars, accessory carrying devices and receiver hitches to provide a tight operative fit for the receiver pin lock 120.

Referring to FIG. 14, the receiver pin lock 120 may also be utilized to be operatively inserted into and locked in a 3 inch receiver hitch 132 and drawbar 136. In many embodiments of the 3 inch receiver hitch 132 may include engaging apertures 128 of approximately ¾ of an inch in diameter. In such embodiments, the diameter D₁₄ of the plunger ball 184 of the plunger member 182 in its natural position in FIGS. 3 and 4 may be generally greater than the diameter D₁₉ of the plunger ball 184 of the plunger member 182 in FIG. 14. This results the plunger ball 184 being compressed between the engaging apertures 128 and generally equivalent with the diameter D₁₇ of the engaging apertures 128. In such embodiments, the diameter D₁₉ of the of the plunger ball 184 of the plunger member 182 may be ¾ of an inch and may operatively engage with the ¾ of an inch diameter of the engaging apertures 128 of the drawbar 136. In such embodiments, the receiver pin lock 120 may be selectively engaged with and disengaged from the differently sized drawbars, accessory carrying devices and receiver hitches to provide a tight operative fit for the receiver pin lock 120.

As shown in FIGS. 13 and 14, the receiver pin lock 120 may comprise any number of plunger members 182, including, without limitation of a set of plunger members 188. In particular embodiment shown in FIGS. 13 and 14, the set of plunger members 188 may include three plunger members 182; however, the present teachings contemplate any appropriate number of plunger members 182, including, without limitation, one, two, four, etc. In some embodiments, the set of plunger members 188 may of a different configuration. The set of plunger members 188 may be structured to hold the receiver pin lock 120 in the engaged position when the receiver pin lock 120 is operatively inserted into and locked in a plurality of different sized drawbars and receiver hitches as described above.

While the set of plunger members 188 is described above, the remaining set of plunger members 188 may be structured generally in the same manner. Further, while one side of the set of plunger members 188 is described in detail above, the opposing side may have generally identical structure, i.e., the two sides may be generally symmetrically identical.

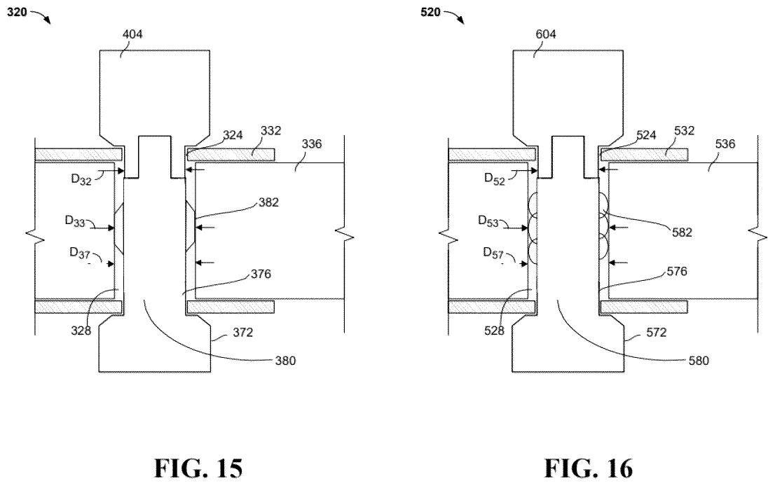

In operation as shown in FIG. 15, the receiver pin lock 320 may be configured to be operatively inserted into and locked in a plurality of different sized drawbars and receiver hitches. By way of a non-limiting example, the receiver pin lock 320 may be configured to be operatively inserted into and locked in at least both of 2½ and 3 inch drawbar 336. In such embodiments, the engaging apertures 324 of the receiver hitch 132 may be approximately ⅝ of an inch in diameter and the engaging apertures 328 of the drawbar 336 may be approximately ⅝ of an inch and ¾ of an inch in diameter.

This configuration enables the offset portion 382 engage the inner wall of the different sized drawbars, accessory carrying device and receiver hitches while the stepped portions 376 engaged with the engaging apertures 324 of the receiver hitch 332. In such embodiment, the diameters D₃₃ of the offset portion 382 may engage with the diameters D₅₇ of the engaging apertures 328 of the drawbar 336 and the diameters D₃₂ of the stepped portions 376 engage with the engaging apertures 324 of the receiver hitch 132, which may provide a tight fit with the engaging apertures 324, 328. This tight fit may eliminate the necessity for additional components, such as sleeves and may reduce the uncertainty of which size receiver lock should be used. The receiver pin lock 320 may “automatically” fit with the appropriately sized engaging apertures 324, 328 and corresponding receiver hitch 332 and drawbar 336, respectively.

In operation as shown in FIG. 16, the receiver pin lock 520 may be configured to be operatively inserted into and locked in a plurality of different sized drawbars and receiver hitches. By way of a non-limiting example, the receiver pin lock 520 may be configured to be operatively inserted into and locked in at least both of 2½ and 3 inch drawbar 536. In such embodiments, the engaging apertures 524 of the receiver hitch 532 may be approximately ⅝ of an inch in diameter and the engaging apertures 528 of the drawbar 536 may be approximately ⅝ of an inch and ¾ of an inch in diameter.

This configuration enables the offset portion 582 engage the inner wall of the different sized drawbars, accessory carrying device and receiver hitches while the stepped portions 576 engaged with the engaging apertures 524 of the receiver hitch 532. In such embodiment, the diameters D₅₃ of the offset portion 582 may engage with the diameters D₅₇ of the engaging apertures 528 of the drawbar 536 and the diameters D₅₂ of the stepped portions 576 engage with the engaging apertures 524 of the receiver hitch 132, which may provide a tight fit with the engaging apertures 524, 528. This tight fit may eliminate the necessity for additional components, such as sleeves and may reduce the uncertainty of which size receiver lock should be used. The receiver pin lock 520 may “automatically” fit with the appropriately sized engaging apertures 524, 528 and corresponding receiver hitch 532 and drawbar 536, respectively.

In order to remove the receiver pin lock 20, the user may insert a key into the opening 112 of the lock 108. The user may rotate or pivot the key and the lock 108 may become disengaged from the engaging end portion 92, which may allow the user to pull the lock member 104 from the engaging end portion 92. The user may then grasp the stop portion 72 and the shank 80 and/or stepped portions 76 and 96 may be removed from the receiver hitch 32 and drawbar 36. The drawbar 36 may then be removed from the receiver hitch 32.

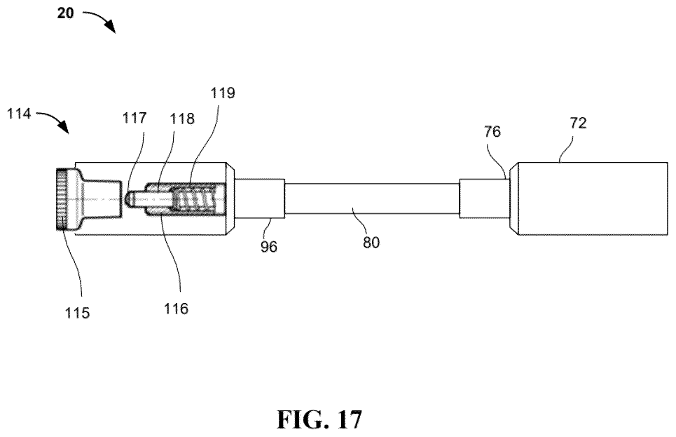

Alternatively, as illustrated in FIG. 17, the receiver pin lock 20 may be biased by a biasing knob member 114 comprising a biasing knob 114 and a basing unit 115. The biasing unit 115 may further include a biasing pin 117, a biasing plunger 118 and a biasing member 119. By way of a non-limiting example, the biasing unit 115 may be threaded, press fit, friction fit, attached through use of a fastener, welding or adhered to the shank 80. The user may pull the biasing knob 114 and the lock 108 may become disengaged from the engaging end portion 92, which may allow the user to pull the lock member 104 from the engaging end portion 92. The user may then grasp the stop portion 72 and the shank 80 and/or stepped portions 76 and 96 may be removed from the receiver hitch 32 and drawbar 36. Similarly, the drawbar 36 may then be removed from the receiver hitch 32. The present teachings, however, are not limited to this configuration.

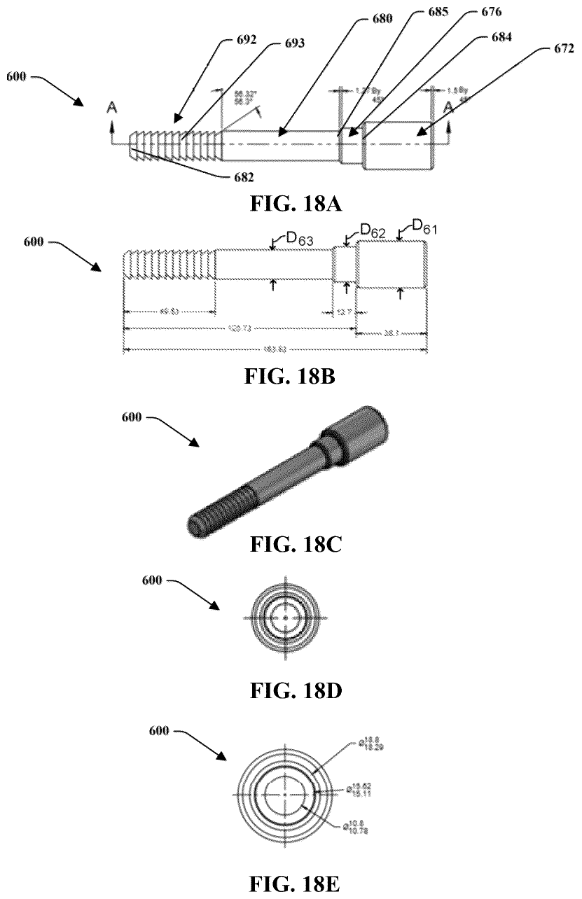

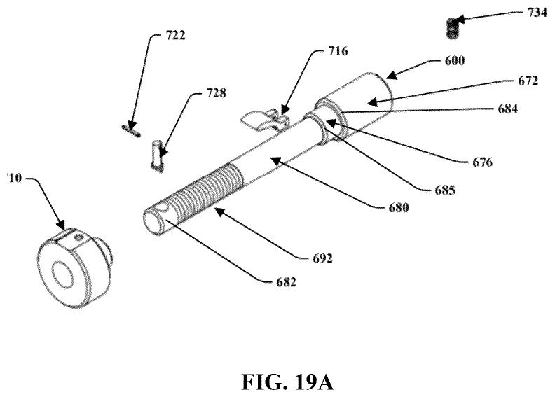

Referring now to FIGS. 18A-E, shown is pin 600. FIG. 18B shows a crossectional view of the embodiment of FIG. 18A along line A-A. The pin 600 may include a stop portion 672, a first stepped portion 676 extending from the stop portion 672, and a shank 680 extending from the stepped portion 676. The stop portion 672, stepped portion 676 and shank 680 may be monolithically formed with each other or may be attached through subsequent operation, e.g., adhering, welding, fastening, or the like. The stop portion 672 may be configured to not pass through either of or both of the engaging apertures 24, 28 of the receiver hitch 32 and drawbar 36, respectively. As shown in FIGS. 18D-E, the stop portion 672 may have a generally cylindrical shape or circular cross-section having a diameter D₆₁. The diameter D₆₁ may be of any appropriate size that prevents such from passing through either of or both of the engaging apertures 24, 28. For example D₆₁ may be larger than ⅝ of an inch, e.g., it may be approximately 1 inch. It should be understood, however, that the stop portion 72 may be of any appropriate shape and size and is not limited to that shown and described.

The stepped portion 676 may be of any appropriate shape and size. By way of a non-limiting example, the stepped portion 676 may extend from the stop portion 672 and be of a smaller diameter D₆₂ than the stop portion 672 diameter D₆₁, such as being 37.5% less in diameter than the stop portion 672. As shown in FIGS. 18D-E, the stepped portion 676 may have a generally cylindrical shape or circular cross-section. In an embodiment, the diameter D₆₂ of the stepped portion 676 may be approximately ¾ of an inch.

Further, a transition portion 684 may be positioned between the stop portion 672 and stepped portion 676. The transition portion 684 may be a continuous or discontinuous transition between the stop portion 672 and stepped portion 676, e.g., the transition portion 684 may act as a ramp between the stop portion 672 and stepped portion 676. In an embodiment, the transition portion 684 may ramp downwards from the stop portion 672 toward the stepped portion 676. In an embodiment, the transition portion 684 may have a drop off to the stepped portion 676 after the downward ramp from the stop portion 672. The transition portion 684 may be of any appropriate configuration and is not limited to that shown. Further still, in some embodiments the pin 600 may not include the transition portion 684 and the stop portion 672 may transition directly into or directly abut the stepped portion 676. As shown, the transition portion 684 may be smaller than the stop portion 672, but larger than the stepped portion 676. In general, the transition portion 684 may be beveled or tapered.

Further, a transition portion 685 may be positioned between the stepped portion 676 and shank 680. The transition portion 685 may be a continuous or discontinuous transition between the stepped portion 676 and shank 680, e.g., the transition portion 685 may act as a ramp between the stepped portion 676 and shank 680. In an embodiment, the transition portion 685 may ramp downwards from the stepped portion 676 toward the shank 680. In an embodiment, the transition portion 685 may have a drop off to the shank 680 after the downward ramp from the stepped portion 676. The transition portion 685 may be of any appropriate configuration and is not limited to that shown. Further still, in some embodiments the pin 600 may not include the transition portion 685 and the stepped portion 676 may transition directly into or directly abut the shank 680. As shown, the transition portion 685 may be smaller than the stepped portion 676, but larger than the shank 680. In general, the transition portion 685 may be beveled or tapered.

The shank 680 may extend from the stepped portion 676 and be integrally formed therewith. In some embodiments, the shank 680 may be monolithically formed with the stepped portion 676, transition portion 684, and stop portion 672. In some embodiments, the shank 680 may be attached with the stepped portion 676 in any appropriate manner, including, without limitation by adhering, welding, or fastening. In yet some embodiments, the shank 680 may be monolithically formed with the stepped portion 676 and transition portion 684 or just the stepped portion 676. The shank 680 may have a generally cylindrical shape or circular cross-section and be of a diameter D₆₃ generally less than the diameter D₆₂ of the stepped portion 676. For example, the shank 680 may have a diameter D₆₃ of about ⅝ of an inch and this diameter D₆₃ may generally extend the entire length of the shank 680, but may also extend a substantial portion of the length of the shank 680, including, without limitation a majority portion of the length of the shank 680. Further, end portions 682 of the shank 680 may have a diameter that is the same, greater than, or less than the diameter D₆₃ of the shank 680.

Together, the diameter D₆₂ of the stepped portion 676 and the diameter D₆₃ of the shank 680, may serve as two step downs from the stop portion 672, e.g., a first step down of the stepped portion 676 and a second step down of the shank 680. In an embodiment, the first step down of the stepped portion 676 may be about ¾ of an inch and a second step down of the shank 680 may be about ⅝ of an inch. As a result, pin 600 may include two step downs.

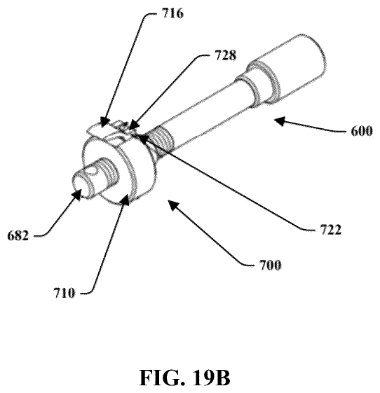

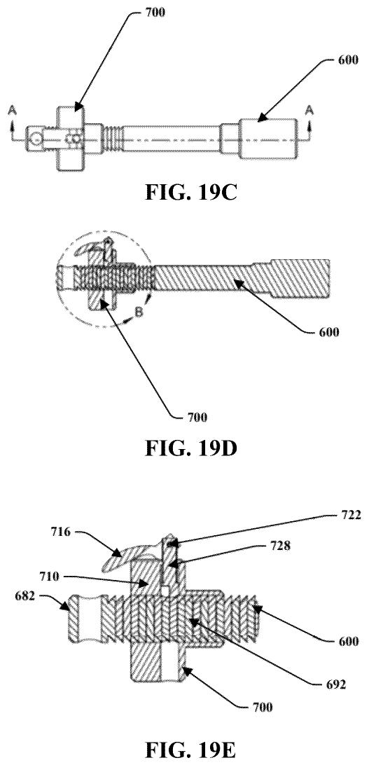

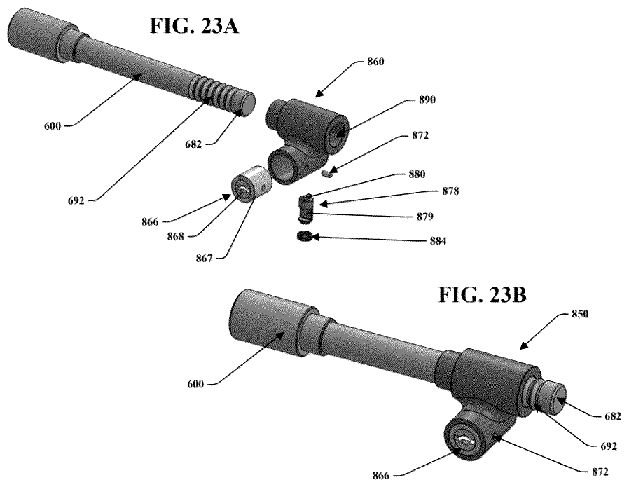

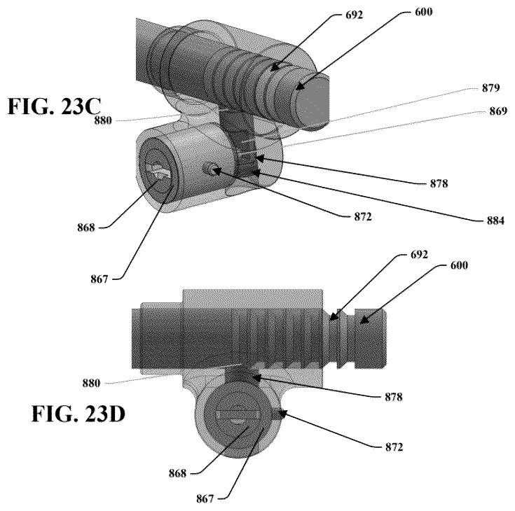

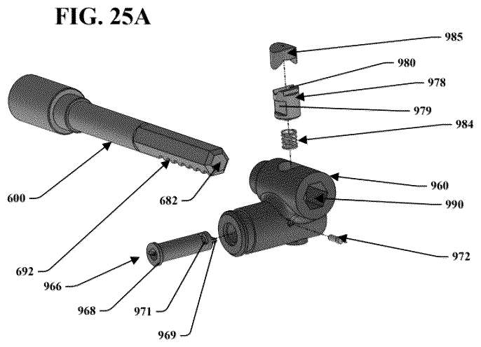

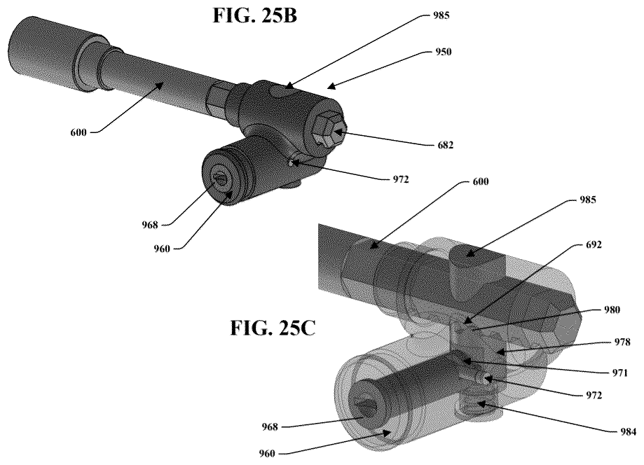

As shown in FIGS. 18A-B, the shank 680 may include an engagement portion 692. The engagement portion 692 may be located toward the end 682 of the shank 680 that is opposite the attachment of the shank 680 to the stepping portion 676 (e.g. the distal end of the shank 680). In an embodiment, the engagement portion 692 comprises between 50% and 10% of the shank 680. The engagement portion 692 to fully extend to, include, or serve as the distal end 682 of the shank 680, as shown in FIG. 18A, for example, or may terminate just before or near the distal end 682 of the shank 680, as shown in FIG. 19A and FIG. 23A, for example. The engagement portion 692 of the pin 600 may selectively engage a corresponding portion on the lock member as described herein. The engagement portion 692 may include any engagement feature, including threading, notches, recesses and protrusions, and the like. In an embodiment, the engagement portion 692 includes a plurality of whistle notches 693. The engagement portion 692 may fully circumscribe the shank 680 as shown in at least FIGS. 18A and 19A, for example, or the engagement portion 692 may be located on a face of the shank 680 or partially circumscribe the shank 680, such as the engagement portion shown in FIG. 25A, for example. The engagement portion 692, in an example, may include a series of tapered protrusions and recesses that may facilitate the forward progression of the pin 600 into a locking member, but that do not allow reverse progression without actuating an unlocking mechanism. As described herein, the locking mechanism may include a spring-loaded release or component that engages with the engagement portion 692 or whistle notches 693, for example.

The pin 600 may be configured to selectively couple with, attach to, mate with, lock with, etc. a locking member. The locking member may be a spring-biased locking member, such as locking members 700, 750, 800, 850, etc., may include a lever locking mechanism, such as locking members 700, 750, 800, may include a key locking mechanism, such as locking members 850, 900, 950, 1000, or may include another mechanism of a combination thereof. In an embodiment, the pin 600 may extend through a receiver hitch 32 and/or draw bar 36, such as that shown in FIG. 1, wherein the stop portion 672 of the pin 600 holds the pin on one side of the receiver hitch 32 and/or draw bar 36 (e.g. the diameter D₆₁ of the stop portion 672 may be larger than the apertures 24, 28 of the receiver hitch 32 and/or draw bar 36) and the distal end 682 and engagement portion 692 extend through and out of the receiver hitch 32 and/or draw bar 36 (e.g. the diameter D₆₃ of the shank 680 may be smaller than the apertures 24, 28 of the receiver hitch 32 and/or draw bar 36), so that the distal end 682 and engagement portion 692 of the pin 600 may selectively couple with the locking member 700 and hold the receiver hitch 32 and draw bar 36, or other components thereto, together.

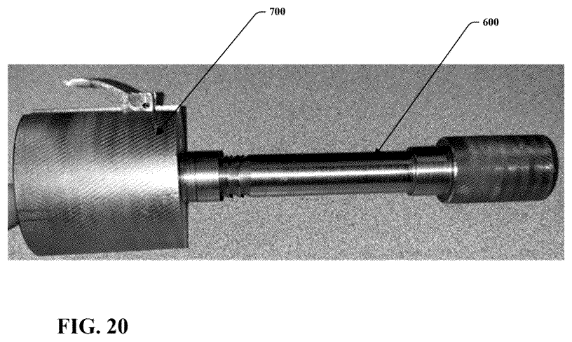

Referring now to FIGS. 19A-E, shown is a locking member or retaining pin assembly 700 that may selectively couple with pin 600. As shown in FIG. 19A illustrating an exploded view of the locking member 700, the locking member 700 may comprise a housing 710, a lever, handle, or actuator 716, a mechanism or retaining pin 722, a plunger 728, and a spring 734. The locking member 700 may further comprise a channel 740 configured to receive the distal end 682 and engagement portion 692 of the pin 600. In an example, the channel 740 may be generally circular or cylindrical in shape. The mechanism pin 722 may attach through and traverse the lever 716, so that the lever 716 may rotate about an axis defined by the mechanism pin 722. The lever 716 may couple with the plunger 728, wherein the plunger 728 extends through the housing 710 of the locking member 700 and is spring-biased by the spring 734 to an engaging position with the pin 600. FIG. 20 shows a prototype of the locking mechanism 700 having a lever 722 coupled with a pin.

Regarding actuation of locking member 700, an operator would install the appropriate receiver reducer and desired ball mount, align component pin holes to each other, insert the pin 600 through the receiver pin hole (such as apertures 24 on a receiver hitch 32, 33, 34, 35) through all to the other side of the receiver hitch 32, 33, 34, 35, attach the retaining pin assembly or locking member 700 to the pin 600 securely, and lock in place with separate padlock or lock directly with a locking member described in this application.

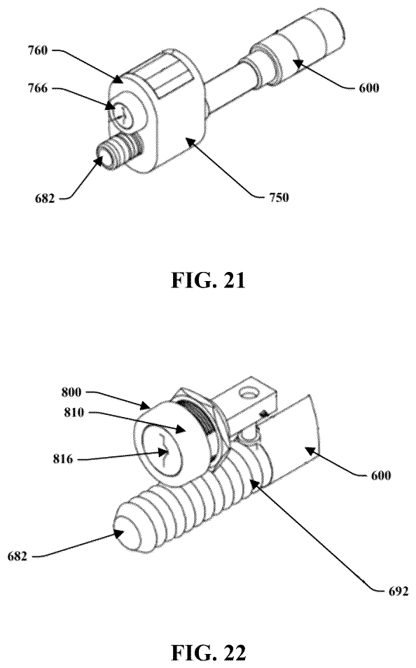

Referring now to FIGS. 20-21, shown are locking members or retaining pin assemblies 750, 800 that may selectively couple with pin 600. Locking members 750, 800 may comprise similar spring locking mechanisms as those described in relation to locking member 700, but instead may include a key lock actuator integrated or incorporated into the housing.

Regarding actuation of locking member 750, 800, an operator would install the appropriate receiver reducer and desired ball mount, align component pin holes to each other, insert the pin 600 through the receiver pin hole (such as apertures 24 on a receiver hitch 32, 33, 34, 35) through all to the other side of the receiver hitch 32, 33, 34, 35, attach the retaining pin assembly or locking member 750, 800 to the pin 600 securely, push key lock in place with or without key, use supplied key to release lock when desired by the operator.

Referring now to FIGS. 23A-D, shown is a locking member or retaining pin assembly 850 that may selectively couple with pin 600. As shown in FIG. 23A illustrating an exploded view of the locking member 850, the locking member 850 may comprise a body or housing 860, a key lock or actuator 866, a dowel pin 872, a plunger 878, and a spring 884. The locking member 850 may further comprise a channel 890 configured to receive the distal end 682 and engagement portion 692 of the pin 600. In an example, the channel 890 may be generally circular or cylindrical in shape. As noted in other embodiments, the channel may also include other shapes other than circular or cylindrical, including hexagonal. The key lock 866 may include a key lock housing 867 and rotatable key lock 868, wherein the rotatable key lock 868 may be positioned within the key lock housing 867 and configured to receive a key and wherein the key lock 866 may insert into a portion of the housing 860. In an embodiment, the key lock 866 may insert into a portion of a housing 860 that is perpendicular to and below the channel 890 configured to receive the pin 600 as shown in FIGS. 23A-D, for example. It is noted that the key lock 866 may be located in any other position on the housing 860 including parallel and above or to the side of the channel 890 configured to receive the pin 600.

The dowel pin 872 may extend through the housing 860 of the locking member 850 into a corresponding recess on the key lock housing 867 to hold the key lock housing 867 in place during, for instance, actuation, rotation, or unlocking of the rotatable key lock 868 within the key lock housing 867 and housing 860 of the locking member 850. The plunger 878 and spring 884 may be coupled to each other. The plunger 878 may include a side or recess 879 that couples to and interacts with an end or protrusion of the rotatable key lock 869. The plunger 878 may further include an engagement portion 880, such as a mating projection, that couples to and interacts with the engaging portion 692, such as the recesses between whistle notches, of the pin 600. The plunger 878 may be spring biased by the spring 884 in direction that pushes the plunger 878 and mating projection 880 into the channel 890 and against the engagement portion 692 of the pin 600 when the pin 600 is selectively inserted into the channel 890.

In an embodiment, as the pin 600 is inserted into and through the channel 890 of the locking member 850, the spring 884 pushes or biases the plunger 878 and engagement portion or mating projection 880 into the channel 890 and against the engagement portion 692 of the pin 600. In an example, a tapered side of the projections of the whistle notches 692 may allow forward progression of the pin 600 through the channel 890, but prevent backward progression of the pin 600 through the channel 890 by the alternating non-tapered sides of the projections of the whistle notches and the recess between the notches. In this way, the pin 600 becomes locked in its position through the channel 890 as it progresses into and through the channel and as the engagement portion of the plunger 880 interacts with the engagement portion 692 of the pin 600.

In order to unlock the locking member 850 and thereby release the engagement portion 880 of the plunger 878 from the engagement portion 692 of the pin 600, a key may be inserted into the key lock 866. The key may rotate the rotatable key lock 868 within the key lock housing 867, for example, in a clockwise direction. The key lock housing 867 may not rotate with the rotation of the rotatable key lock 868 due to the dowel pin 872. During rotation of the rotatable key lock 868 by the key, the end or protrusion of the rotatable key lock 869 may rotate within the side or recess 879 of the plunger 878 and pull the plunger 878 in a direction that is opposite its engagement with the pin 600 and against its spring bias. The engagement portion 880 of the plunger 878 may thereby be released from the engagement portion 692 of the pin 600 and the pin 600 unlocked from the locking member 850.

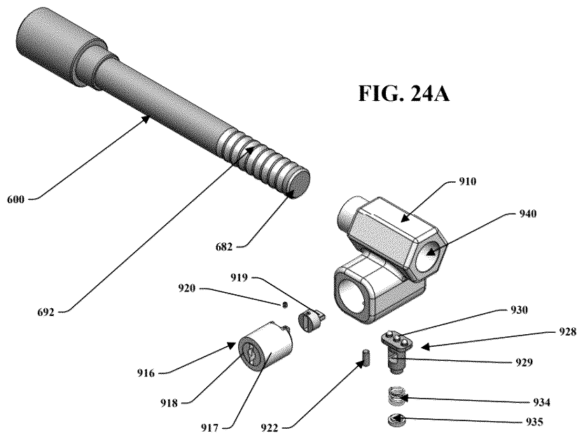

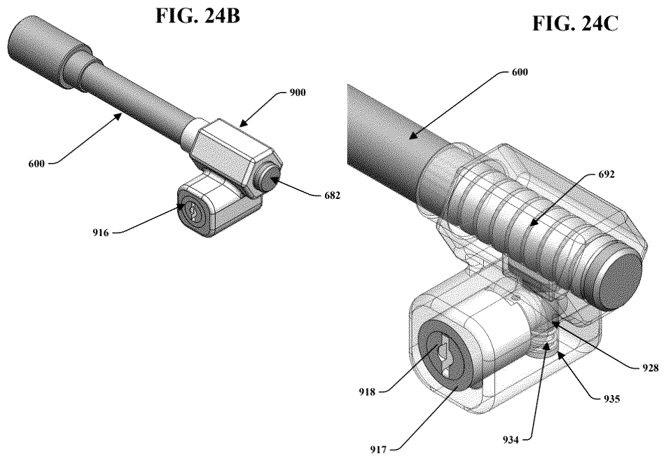

Referring now to FIGS. 24A-C, shown is a locking member or retaining pin assembly 900 that may selectively couple with pin 600. As shown in FIG. 23A illustrating an exploded view of the locking member 900, the locking member 900 may comprise a body or housing 910, a key lock or actuator 916, a dowel pin 922, a plunger 928, and a spring 934. The locking member 850 may further comprise a channel 940 configured to receive the distal end 682 and engagement portion 692 of the pin 600. In an example, the channel 940 may be generally circular or cylindrical in shape. As noted in other embodiments, the channel may also include other shapes other than circular or cylindrical, including hexagonal. The key lock 916 may include a key lock housing 917 and rotatable key lock 918, wherein the rotatable key lock 918 may be positioned within the key lock housing 917 and configured to receive a key and wherein the key lock 916 may insert into a portion of the housing 910. In an embodiment, the key lock 916 may insert into a portion of a housing 910 that is perpendicular to and below the channel 940 configured to receive the pin 600 as shown in FIGS. 24A-C, for example. It is noted that the key lock 916 may be located in any other position on the housing 910 including parallel and above or to the side of the channel 940 configured to receive the pin 600.

The dowel pin 922 may extend through the housing 910 of the locking member 900 into a corresponding recess on the key lock housing 917 to hold the key lock housing 917 in place during, for instance, actuation, rotation, or unlocking of the rotatable key lock 918 within the key lock housing 917 and housing 910 of the locking member 900. The plunger 928 and spring 934 may be coupled to each other. An end cap 935 may also be used to cover the spring 934 if there is a corresponding aperture in the housing 910 of the locking member 900. The plunger 928 may include a side or recess 929 that couples to and interacts with an end or protrusion of the rotatable key lock 919. As shown in FIG. 24A, the end or protrusion of the rotatable key lock 919 may actually be a separate piece that couples to the rotatable key lock 918. The separate end or protrusion of the rotatable key lock 919 may couple to the rotatable key lock 918 by a fastener, dowel, screw, or the like 920. The plunger 928 may further include an engagement portion 930, such as a mating projection, that couples to and interacts with the engaging portion 692, such as the recesses between whistle notches, of the pin 600. The plunger 928 may be spring biased by the spring 934 in direction that pushes the plunger 928 and mating projection 930 into the channel 940 and against the engagement portion 692 of the pin 600 when the pin 600 is selectively inserted into the channel 940.

In an embodiment, as the pin 600 is inserted into and through the channel 910 of the locking member 900, the spring 934 pushes or biases the plunger 928 and engagement portion or mating projection 930 into the channel 940 and against the engagement portion 692 of the pin 600. In an example, a tapered side of the projections of the whistle notches 692 may allow forward progression of the pin 600 through the channel 940, but prevent backward progression of the pin 600 through the channel 940 by the alternating recesses between projections the whistle notches. As shown in FIG. 24A, the engagement portion 930 of the plunger 928 may include multiple projections that simultaneously interact and lock into multiple recesses of the engagement portion 692 of the pin 600. In this way, the pin 600 becomes locked in its position through the channel 940 as it progresses into and through the channel and as the engagement portion of the plunger 930 interacts with the engagement portion 692 of the pin 600.

In order to unlock the locking member 900 and thereby release the engagement portion 930 of the plunger 928 from the engagement portion 692 of the pin 600, a key may be inserted into the key lock 916. The key may rotate the rotatable key lock 918 within the key lock housing 917, for example, in a clockwise direction. The key lock housing 917 may not rotate with the rotation of the rotatable key lock 918 due to the dowel pin 922. During rotation of the rotatable key lock 918 by the key, the end or protrusion of the rotatable key lock 919 may rotate within the side or recess 929 of the plunger 928 and pull the plunger 928 in a direction that is opposite its engagement with the pin 600 and against its spring bias. The engagement portion 930 of the plunger 928 may thereby be released from the engagement portion 692 of the pin 600 and the pin 600 unlocked from the locking member 900.

The locking member 900 may be similar to locking member 850, for example, except further including an end cap 935 positioned adjacent to the spring 934 and having the protrusion of the rotatable key lock 919 separate from the rotatable key lock 918 but selectively attachable thereto.

Referring now to FIGS. 25A-C, shown is a locking member or retaining pin assembly 950 that may selectively couple with pin 600. As shown in FIG. 25A illustrating an exploded view of the locking member 950, the locking member 950 may comprise a body or housing 960, a key lock or actuator 966, a dowel pin 972, a plunger 978, and a spring 984. The locking member 950 may further comprise a channel 990 configured to receive the distal end 682 and engagement portion 692 of the pin 600. In an example, the channel 990 may be generally hexagonal. The hexagonal shape of the channel 990 (and the hexagonal and tapered shape of the pin 600 and the distal end 682 of the pin 600) may facilitate interaction with the pin 600 by both an end cap 985 and the plunger 978 on opposite sides of the pin 600 as shown in FIG. 25C, for example. In an embodiment, the key lock 966 may include a rotatable key lock 968 positioned within housing 960 of the locking member 950 and be configured to receive a key. While this embodiment as shown may not include a separate key lock housing, it is noted that a separate key lock housing may be so included (and vice versa where embodiments shown with a key lock housing may be have the key lock housing omitted). In an embodiment, the key lock 966 may insert into a portion of a housing 960 that is perpendicular to and below the channel 990 configured to receive the pin 600 as shown in FIGS. 25A-C, for example. It is noted that the key lock 966 may be located in any other position on the housing 960 including parallel and above or to the side of the channel 990 configured to receive the pin 600.

The dowel pin 972 may extend through the housing 960 of the locking member 950 into a corresponding channel 971 on the rotatable key lock housing 968 to control or limit the rotation of the rotatable key lock 968 during, for instance, actuation, rotation, or unlocking of the rotatable key lock 968 within the housing 960 of the locking member 950. In an example, the dowel pin 972 may be at a first position in the channel 971 of the rotatable key lock housing 968 when the locking member 950 is in a locking position and may move through the channel 971 of the rotatable key lock 968 to a second position as the locking member 950 is being unlocked with a key and until the locking member 950 is in an unlocked position. The rotation of the rotatable key lock housing 968 may be limited by the length of the channel 917 and the ends of the channel may prevent further movement of the dowel pin 917 in that direction. Although not shown, other embodiments having a key housing may include a similar channel and rotation/stop mechanism between the rotatable key lock and the key lock housing. For example, the rotatable key lock may include the same channel on its surface and the dowel may traverse but the housing of the locking member and the key lock housing to engage the channel on the rotatable key lock. The plunger 978 and spring 984 of the locking member 950 may be coupled to each other. An end cap 985 may also be used to cover the plunger 978 and interact with the pin 600 if there is a corresponding aperture in the housing 910 of the locking member 900. The plunger 978 may include a side or recess 979 that couples to and interacts with an end or protrusion of the rotatable key lock 969. The plunger 978 may further include an engagement portion 980, such as a mating projection, that couples to and interacts with the engaging portion 692, such as the recesses between whistle notches, of the pin 600. The plunger 978 may be spring biased by the spring 984 in direction that pushes the plunger 978 and mating projection 980 into the channel 990 and against the engagement portion 692 of the pin 600 when the pin 600 is selectively inserted into the channel 990.

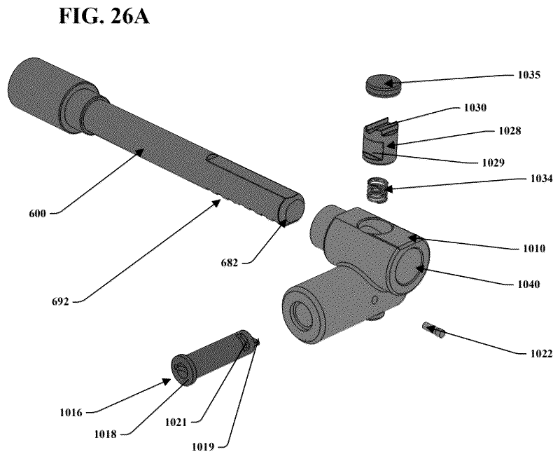

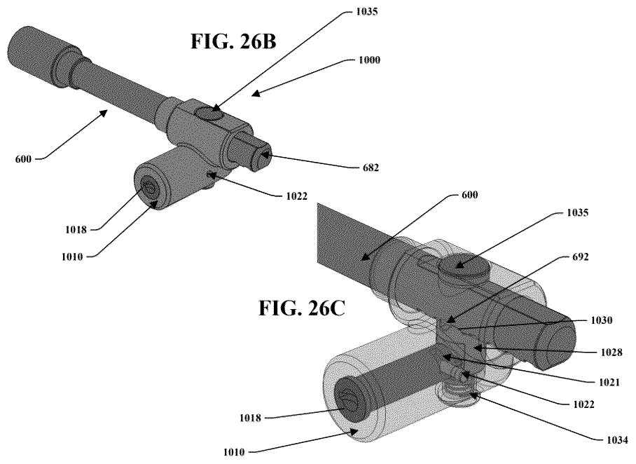

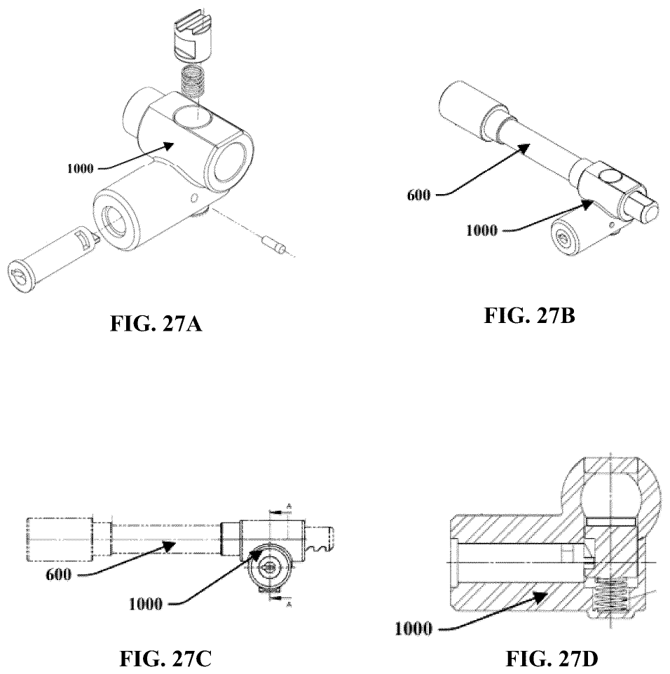

In an embodiment, as the pin 600 is inserted into and through the channel 990 of the locking member 950, the spring 984 pushes or biases the plunger 978 and engagement portion or mating projection 980 into the channel 990 and against the engagement portion 692 of the pin 600. In an example, a tapered distal end 682 of the pin 600 may interact with the plunger 978 and force the plunger 978 in a direction against its spring bias. In an example, the tapered distal end 682 of the pin 600 may move between the plunger 978 and the end cap 985. In an example, a tapered side of the projections of the whistle notches 692 may allow forward progression of the pin 600 through the channel 990, but prevent backward progression of the pin 600 through the channel 990 by the alternating non-tapered sides of the projections of the whistle notches and the recess between the notches. In this way, the pin 600 becomes locked in its position through the channel 990 as it progresses into and through the channel and as the engagement portion of the plunger 980 interacts with the engagement portion 692 of the pin 600. In an embodiment, the side of the pin 600 opposite the side that engages with the plunger 978 of the locking member 950 may interact with the end cap 985. The end cap 985 may include an engagement portion that engages an engaging portion of the pin (and may be similar or different than the engagement portion of the plunger 980 that interacts with the engagement portion 692 of the pin 600) or the end cap 985 and the side of the pin 600 may be substantially planar, flat, circular, square, hexagonal, etc. As shown in FIGS. 25A-C, the side of the pin 600 may be flat and hexagonal, and the end cap 985 may have mating features. As shown in FIGS. 26A-C, the side of the pin 600 may be flat and circular, and the end cap 1035 may have mating features.

In order to unlock the locking member 950 and thereby release the engagement portion 980 of the plunger 978 from the engagement portion 692 of the pin 600, a key may be inserted into the key lock 966. The key may rotate the rotatable key lock 968 within the key lock housing 967, for example, in a clockwise direction. The key lock housing 967 may not rotate with the rotation of the rotatable key lock 968 due to the dowel pin 972. During rotation of the rotatable key lock 968 by the key, the end or protrusion of the rotatable key lock 869 may rotate within the side or recess 979 of the plunger 978 and pull the plunger 978 in a direction that is opposite its engagement with the pin 600 and against its spring bias. The engagement portion 980 of the plunger 978 may thereby be released from the engagement portion 692 of the pin 600 and the pin 600 unlocked from the locking member 950.

The locking member 950 may be similar to locking member 850 or 900, for example, except not including a key lock housing 867, 917, having dowel 972 facilitate rotation of the rotatable key lock 918, further including an end cap 985 selectively adjacent to or opposite the plunger 978 (specifically adjacent to or opposite the engagement portion 980 of the plunger 978) and that also interacts with the shank 680 of the pin 600, and further having a channel 990 that is not circular and that, in an example, is hexagonal.

The locking member 1000 shown in FIGS. 26A-C and 27A-D may be similar to locking member 950, except in the shape of the engagement portions 692 of the pin 600 and the corresponding engagement portions 1030 of the plunger 1028, the shape of the shank 680 of the pin 600 (flat and hexagonal versus flat and circular), and the shape of the end cap 1035 which is configured to mate with the flat and circular shape of the shank 680 of the pin 600.

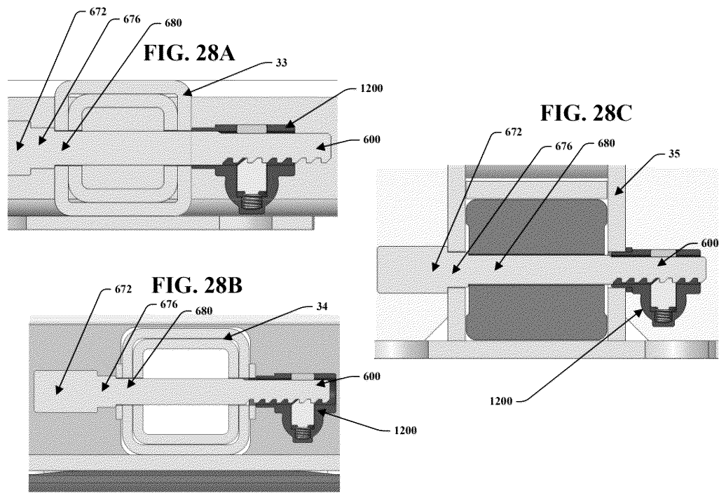

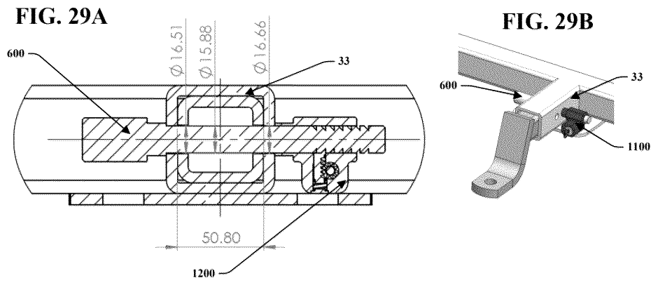

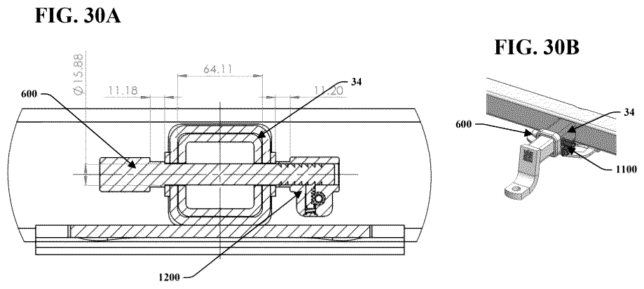

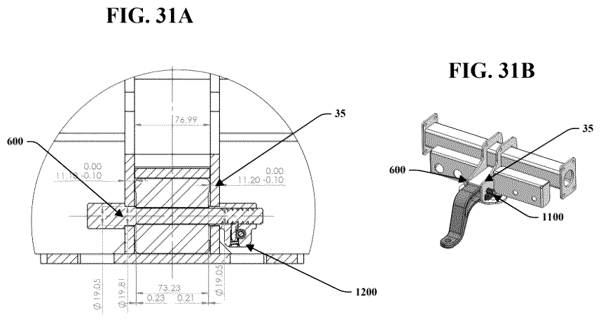

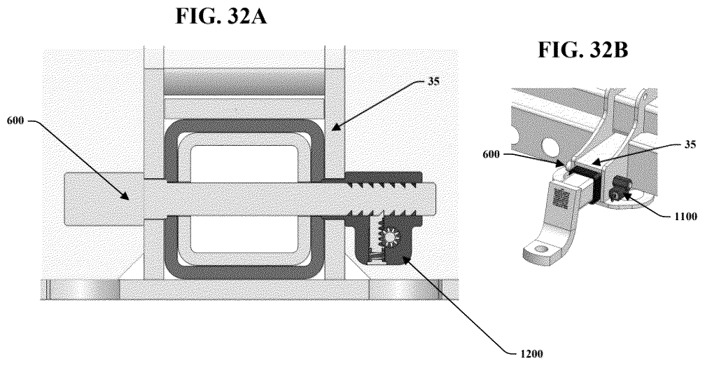

Turning to FIGS. 28A-C, shown are the pin 600 and locking member 700, 750, 800, 850, 900, 950, 1000 (general locking member referred to as 1200) as attached through a receiver hitch, such as receiver hitch 32, 33, 34, 35. FIGS. 28A and 29A-B show the pin 600 and locking member 700, 750, 800, 850, 900, 950, 1000 (1200) as attached through a 2 inch receiver hitch 33 having ⅝ of an inch apertures. FIGS. 28B and 30A-B show the pin 600 and locking member 700, 750, 800, 850, 900, 950, 1000 (1200) as attached through a 2.5 inch receiver hitch 34 having ⅝ of an inch apertures. FIGS. 28C, 31A-B, and 32A-B show the pin 600 and locking member 700, 750, 800, 850, 900, 950, 1000 (1200) as attached through a 3 inch receiver hitch 35 having ¾ of an inch apertures. As shown, due to the two step downs on pin 600, the diameter D₆₂ of the stepped portion 676 as a first step down and the diameter D₆₃ of the shank 680 as a second step down, the pin 600 is able to be secured to all of the 2 inch, 2.5 inch, and 3 inch receiver hitches 33, 34, 35 having apertures with an opening ¾ to ⅝ of an inch.

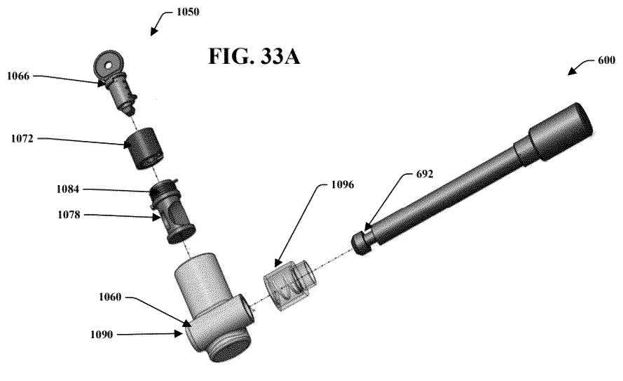

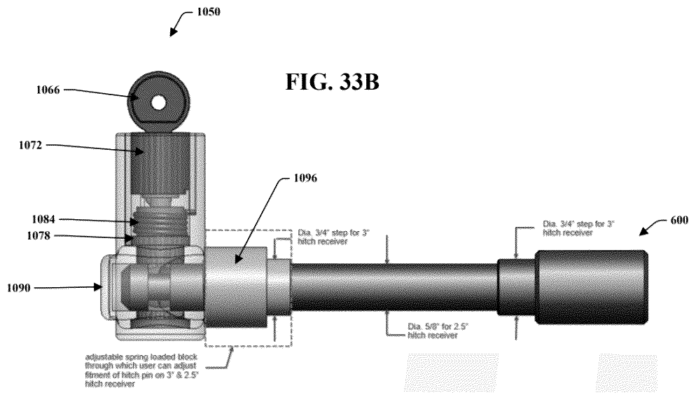

In an example, since the first step down of the stepped portion 676 of the pin 600 may be about ¾ of an inch, this stepped portion 676 of the pin 600 may enter into the aperture for the 3 inch receiver hitches 35 having a ¾ an inch opening. The next step up portion, such as the stop portion 672 having a larger diameter may prevent the pin 600 from moving entirely through the receiver hitch 35, see FIGS. 28C, 31A-B, and 32A-B. Since the shank 680 having a smaller diameter of ⅝ of an inch thereby extends through the other side of the receiver hitch 35 through an aperture of a size ¾ of an inch to engage the locking member 700, 750, 800, 850, 900, 950, 1000, the locking member 700, 750, 800, 850, 900, 950, 1000 may include a portion that extends over the shank 680 and into the aperture of the receiver assembly 35. In an embodiment, this portion of the locking member 700, 750, 800, 850, 900, 950, 1000 that extends over the shank 680 and into the aperture of the receiver hitch 35 may have a diameter of ¾ an inch so that the connection of the pin and locking member through the receiver hitch 35 is secure on both sides, see FIGS. 28C, 31A-B, and 32A-B. This portion of the locking member 700, 750, 800, 850, 900, 950, 1000 that extends over the shank 680 and into the aperture of the receiver hitch 35 may also be provided as a separate component attachable between the locking member 700, 750, 800, 850, 900, 950, 1000 and the pin 600, see attachment 1096 of FIG. 33A and 1146 of FIG. 25.

In an example, since the second step down of the shank 680 of the pin 600 may be about ⅝ of an inch, this shank 680 of the pin 600 may enter into the aperture for the 2 inch receiver hitches 33 having a ⅝ of an inch opening. The next step up portion, such as the stepped portion 676 having a larger diameter may prevent the pin 600 from moving entirely through the receiver hitch 33, see FIGS. 28A and 29A-B. Since the shank 680 having a smaller diameter of ⅝ of an inch thereby extends through the other side of the receiver hitch 33 through an aperture of a size ⅝ of an inch to engage the locking member 700, 750, 800, 850, 900, 950, 1000, the locking member 700, 750, 800, 850, 900, 950, 1000 need not a portion that extends into the aperture of the receiver assembly 33. In an embodiment, the portion of the shank 680 that engages the locking member 700, 750, 800, 850, 900, 950, 1000 and extends out of the aperture of the receiver hitch 33 may already have a diameter of ⅝ an inch so that the connection of the pin and locking member through the receiver hitch 33 is secure on both sides, see FIGS. 28A and 29A-B. In an embodiment, the portion of the locking member 700, 750, 800, 850, 900, 950, 1000 that extends over the shank 680 and that may have a diameter of ¾ an inch may still extend over the shank 680 when attached to the pin 600, but instead of entering into the larger sized aperture of the 3 inch receiver hitch 35 having a diameter of ¾ an inch, the portion may instead directly abut or lie adjacent to the 2 inch receiver hitch 33 having a diameter of ⅝ an inch.

Similar geometries including which portions of the pin 600 may enter into the apertures and which may serve as a stop are similar for 2.5 inch receiver hitches 34 which also have ⅝ of an inch apertures like 2 inch hitch receivers 33, see FIGS. 28B and 30A-B. As a result, the pin 600 and locking member 700, 750, 800, 850, 900, 950, 1000 are configured to be used with any desired receiver hitch and provide a secure fit even despite the differences in the aperture sizes between different receiver hitches.

Referring now to FIGS. 33A-B, shown is a locking member or retaining pin assembly 1050 that may selectively couple with pin 600. As shown in FIG. 33A illustrating an exploded view of the locking member 1050, the locking member 1050 may comprise a body or housing 1060, a rotatable actuator 1066, a shell 1072, a roto-core 1078, and a torsion spring 1084. The locking member 1050 may further comprise a channel 1090 configured to receive the distal end 682 and engagement portion 692 of the pin 600. In an example, the channel 890 may be generally circular or cylindrical in shape. As noted in other embodiments, the channel may also include other shapes other than circular or cylindrical, including hexagonal. The rotatable actuator 1066 may insert into a portion of the housing 1060. In an embodiment, the rotatable actuator 1066 may insert into a portion of a housing 1060 that is perpendicular to the channel 1090 configured to receive the pin 600 as shown in FIGS. 33A-B, for example. It is noted that the rotatable actuator 1066 may be located in any other position on the housing 1060 including parallel and above or to the side of the channel 1090 configured to receive the pin 600.

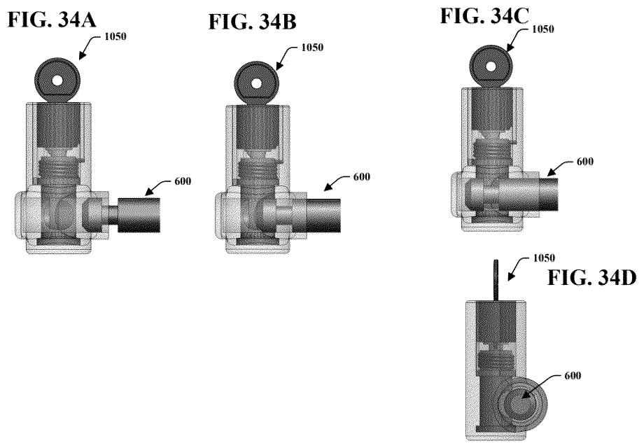

FIGS. 34A-D show the insertion of the pin 600 into locking member 1050. In an embodiment, the roto-core 1078 may snap-lock into the engagement portion or groove 692 of the pin 600. For example, as in FIG. 34A, the initial position of locking may be blocked due to the roto-core 1078 and torsion spring 1084. As in FIG. 34B, the insertion of pin 600 may be actuated by applying force against the roto-core 1078 and torsion spring 1084. Once inserted, as shown in FIG. 34C-D, the roto-core 1078 regains its original position and fits into the engagement portion or groove 692 of the pin 600 due to the torsion spring 1084.

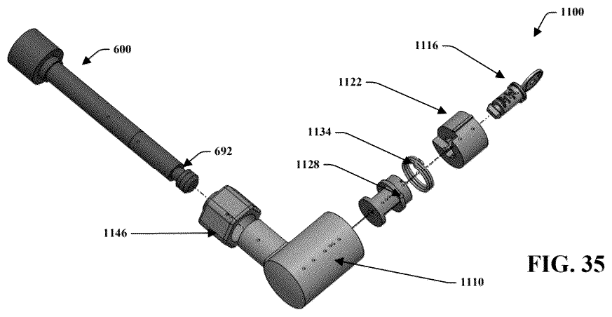

Referring now to FIG. 35, shown is a locking member or retaining pin assembly 1100 that may selectively couple with pin 600. As shown in FIG. 35 illustrating an exploded view of the locking member 1100, the locking member 1100 may comprise a body or housing 1110, a rotatable actuator 1116, a shell 1122, a roto-core 1128, and a torsion spring 1134. The locking member 1100 may further comprise a channel 1140 configured to receive the distal end 682 and engagement portion 692 of the pin 600. In an example, the channel 1140 may be generally circular or cylindrical in shape. As noted in other embodiments, the channel may also include other shapes other than circular or cylindrical, including hexagonal. The rotatable actuator 1116 may insert into a portion of the housing 1110. In an embodiment, the rotatable actuator 1116 may insert into a portion of a housing 1110 that is perpendicular to the channel 1140 configured to receive the pin 600 as shown in FIGS. 33A-B, for example. It is noted that the rotatable actuator 1116 may be located in any other position on the housing 1110 including parallel and above or to the side of the channel 1140 configured to receive the pin 600.

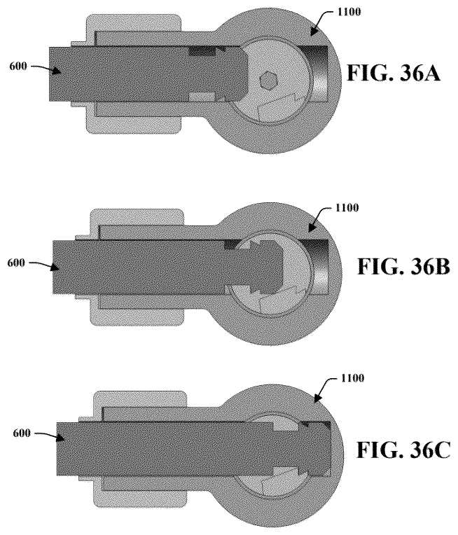

FIGS. 36A-C show the insertion of the pin 600 into locking member 110. In an embodiment, the roto-core 1128 may snap-lock into the engagement portion or groove 692 of the pin 600. For example, as in FIG. 36A, the initial position of locking may be blocked due to the roto-core 1128 and torsion spring 1134. As in FIG. 36B, the insertion of pin 600 may be actuated by applying force against the roto-core 1128 and torsion spring 1134. Once inserted, as shown in FIG. 36C, the roto-core 1128 regains its original position and fits into the engagement portion or groove 692 of the pin 600 due to the torsion spring 1084.

In both locking members 1050, 1100, the pin 600 may fully engage within the housing 1060, 1110 of the locking members 1050, 1100 and, in an embodiment, no part of the pin 600 may extend through the housing 1060, 1110 and be exposed therefrom. Such configuration may be advantageous or desirable under certain circumstances such as by being safe from a hammer hit or other attempt to break through the lock and by avoiding shimming.

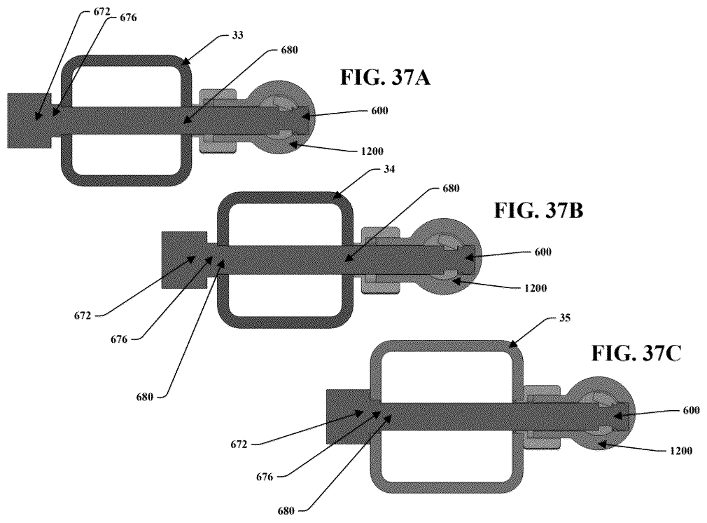

As shown in FIGS. 37A-C, the pin 600 and locking members 1050, 1100 (general locking member referred to as 1200) may be used with any of 2 inch, 2.5 inch, and 3 inch receiver assemblies 33, 34, 35 as similarly described for locking members 700, 750, 800, 850, 900, 950, 1000.

In an example, since the first step down of the stepped portion 676 of the pin 600 may be about ¾ of an inch, this stepped portion 676 of the pin 600 may enter into the aperture for the 3 inch receiver hitches 35 having a ¾ an inch opening. The next step up portion, such as the stop portion 672 having a larger diameter may prevent the pin 600 from moving entirely through the receiver hitch 35, see FIG. 37C. Since the shank 680 having a smaller diameter of ⅝ of an inch thereby extends through the other side of the receiver hitch 35 through an aperture of a size ¾ of an inch to engage the locking member 1050, 1100, the locking member 1050, 1100 may include a portion (such as 1096, 1146) that extends over the shank 680 and into the aperture of the receiver assembly 35. In an embodiment, this portion of the locking member 1050, 1100 that extends over the shank 680 and into the aperture of the receiver hitch 35 may have a diameter of ¾ an inch so that the connection of the pin and locking member through the receiver hitch 35 is secure on both sides, see FIG. 37C. This portion of the locking member 1050, 1100 that extends over the shank 680 and into the aperture of the receiver hitch 35 may also be provided as a separate component attachable between the locking member 1050, 1100, see attachment 1096 of FIG. 33A and 1146 of FIG. 25.

In an example, since the second step down of the shank 680 of the pin 600 may be about ⅝ of an inch, this shank 680 of the pin 600 may enter into the aperture for the 2 inch receiver hitches 33 and the 2.5 inch receiver hitches 34 having a ⅝ of an inch opening. The next step up portion, such as the stepped portion 676 having a larger diameter may prevent the pin 600 from moving entirely through the receiver hitch 33, 34 see FIGS. 37A-B. Since the shank 680 having a smaller diameter of ⅝ of an inch thereby extends through the other side of the receiver hitch 33, 34 through an aperture of a size ⅝ of an inch to engage the locking member 1050, 1100, the locking member 1050, 1100 need not a portion that extends into the aperture of the receiver hitch 33, 34. In an embodiment, the portion of the shank 680 that engages the locking member 1050, 1100 and extends out of the aperture of the receiver hitch 33, 34 may already have a diameter of ⅝ an inch so that the connection of the pin and locking member through the receiver hitch 33, 34 is secure on both sides, see FIGS. 37A-B. In an embodiment, the portion of the locking member 1050, 1100 that extends over the shank 680 and that may have a diameter of ¾ an inch may still extend over the shank 680 when attached to the pin 600, but instead of entering into the larger sized aperture of the 3 inch receiver hitch 35 having a diameter of ¾ an inch, the portion may instead directly abut or lie adjacent to the 2 inch receiver hitch 33, 34 having a diameter of ⅝ an inch.

Although certain variations in the configurations and features of the pin 600 and locking members 700, 750, 800, 850, 900, 950, 1000, 1050, 1100 may be described herein as relating to a specific embodiment of the assembly or corresponding 600 and locking members 700, 750, 800, 850, 900, 950, 1000, 1050, 1100, it is noted that these variations in configurations and features may be adapted and applied to any of the embodiments without departing from the original disclosure. For example, while some FIGs. show a pin having an engagement portion 692 that completely circumscribes the shank 680 and others where the engagement portion 692 is only located on a face of or partially circumscribes the shank 680, any of the locking members described herein may be adapted to accommodate either version of the pins. Similarly, although some FIGs. show a housing of the locking member that fully covers the pin even in a locked position and others where the pin extends through the housing of the locking member when in a locked position, any of the pins or locking members described herein may be adapted to completely cover the pin or allow the pin to extend through the housing. These two examples are merely illustrative and any variations in the configurations and features of the pin 600 and locking members 700, 750, 800, 850, 900, 950, 1000, 1050, 1100 may be similarly adapted to any other embodiments described herein.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. (canceled)

2. (canceled)

3. (canceled)

4. (canceled)

5. A receiver pin lock for insertion into first and second sized opposed engaging apertures of first and second hitch receivers, the receiver pin lock comprising:
a stem;
a first stepped portion extend from the stem;
a lock member selectively engageable with the stem, the lock member preventing removal of stem from either of the first and second hitch receivers; and
a second stepped portion extending from the first stepped portion, wherein the stem is configured to operatively engage the first sized engaging apertures of the first hitch receiver and the second stepped portion is configured to operatively engage the second sized engaging apertures of the second hitch receiver.

6. The receiver pin lock of claim 5, wherein the second stepped portion include a plurality of plunger members axially spaced and radially disposed on the stem.

7. The receiver pin lock of claim 6, wherein the plurality of plunger members include a diameter larger than the first stepped portion.

8. The receiver pin lock of claim 7, wherein the second stepped portion include three plunger members selectively engaged with the second sized engaging apertures of the second hitch receiver.

9. The receiver pin lock of claim 7, the plurality of plunger members further comprising a plunger ball and a plunger biasing member.

10. The receiver pin lock of claim 5, wherein the second stepped portion further include an offset portion bent radially outward from the stem.

11. The receiver pin lock of claim 5, wherein the second stepped portion further include a spiral portion bent radially outward and extending rotatably from the stem.

12. The receiver pin lock of claim 5, further including a biasing knob member.
